(19) United States
(12) Patent Application Publication
(10) Pub. No.: US 2023/0281686 A1
(43) Pub. Date: Sep. 7, 2023

(54) DEVICE, SYSTEM AND METHOD FOR INITIATING REMEDIAL ACTIONS BASED ON ALTERED PROVIDER OBJECTS

(71) Applicant: AMADEUS S.A.S., Biot (FR)

(72) Inventors: Rodolphe Gregory Alexandre TEXIER, Vallauris (FR); Corinne Francoise Pascale LANDRA, Opio (FR)

(21) Appl. No.: 17/684,513

(22) Filed: Mar. 2, 2022

(51) Int. Cl. G06Q 30/06; G06Q 30/02

(52) U.S. Cl. CPC G06Q 30/0605; G06Q 30/0283

(57) ABSTRACT

A device, system and method initiating remedial actions based on altered provider objects are provided. A device generates a provider object representing at least one item provided by a provider system, the provider object including data, the provider object associated with a request from a first client device. The device alters the data to identify the provider object as being associated with the first client device, to generate an altered provider object comprising altered data that identifies the first client device, and provides, the altered provider object to the first client device. The device receives the altered data of the altered provider object, and identifies the first client device from the altered data. In response to determining a lack of association between the first client device and the second client device, the device initiates a remedial action.

### FIELD

The specification relates generally to altered provider objects, and specifically to a device, system and method for initiating remedial actions based on altered provider objects.

### BACKGROUND

The provision of various provider objects representing products, including for example travel-related goods and services (e.g. flights, hotel reservations, and the like) typically requires various discrete entities to exchange data defining various aspects of the products. Examples of such entities, in the context of travel-related products, include airlines, travel agencies, end users, reservation systems, and the like. Although such entities may be configured to exchange data according to a standardized format (e.g. according to the eXtensible Markup Language (XML)-based New Distribution Capability (NDC) standard in the context of travel-related products), they may nonetheless employ different mechanisms to initiate the exchange of data and furthermore some entities may attempt to hide their identity to order products.

### SUMMARY

A first aspect of the present specification provides a method comprising: generating, via one or more computing devices, a provider object representing at least one item provided by a provider system, the provider object including data, the provider object associated with a request from a first client device; altering, via the one or more computing devices, the data to identify the provider object as being associated with the first client device, to generate an altered provider object comprising altered data that identifies the first client device; providing, via the one or more computing devices, the altered provider object to the first client device; receiving, via the one or more computing devices, the altered data of the altered provider object, the altered data being one or more of received from a second client device, captured at the second client device, and associated with the second client device; identifying, via the one or more computing devices, the first client device from the altered data; and in response to determining a lack of association between the first client device and the second client device, initiating a remedial action against one or more of the first client device and the second client device.

At the first aspect, altering the data may comprises one or more of: embedding one or more identifiers of the first client device into the altered data; embedding the one or more identifiers of the first client device into media identified by the altered data; embedding the one or more identifiers of the first client device into one or more of a name and a network address of the media identified by the altered data; changing a first pricing structure of the data to second pricing structure of the altered data, the second pricing structure identifying the first client device; changing an alphanumeric identifier associated with the provider object to identify the first client device; and adding text to the altered data that identifies the first client device.

At the first aspect, determining the lack of association between the first client device and the second client device may occur using a memory storing associations between client devices.

At the first aspect, determining the lack of association between the first client device and the second client device may be based on text of the altered data that identifies the first client device, the text associated with the first client device and not the second client device.

At the first aspect, the remedial action may comprise one or more of: invalidating the provider object; denying access to the provider object by one or more of the first client device and the second client device, and denial of the access to the provider object may occur temporarily or permanently; changing further provider objects associated with the first client device to respective provider objects associated with the second client device; changing prices or services of the further provider objects associated with the first client device to altered prices or altered services; and, one or more of initiating and applying a financial penalty against one or more of the first client device and the second client device.

At the first aspect, the method may further comprise: requesting, via the one or more computing devices, the provider object from the second client device; receiving, via the one or more computing devices, a request for the provider object from the first client device, the provider object generated in response to the request; providing, via the one or more computing devices, the altered provider object, including the altered data, to the first client device; and receiving, via the one or more computing devices, the altered data of the altered provider object from the second client device.

At the first aspect, receiving the altered data may occur as part of receiving scraped content associated with the second client device.

At the first aspect, receiving the altered data may occur by receiving one or more of an image of the altered data and a scan of the altered data.

A second aspect of the present specification provides a computing device comprising: a communication interface; and a controller configured to: generate a provider object representing at least one item provided by a provider system, the provider object including data, the provider object associated with a request from a first client device; alter the data to identify the provider object as being associated with the first client device, to generate an altered provider object comprising altered data that identifies the first client device; provide, via the communication interface, the altered provider object to the first client device; receive, via the communication interface, the altered data of the altered provider object, the altered data being one or more of received from a second client device, captured at the second client device, and associated with the second client device; identify the first client device from the altered data; and in response to determining a lack of association between the first client device and the second client device, initiate a remedial action against one or more of the first client device and the second client device.

At the second aspect, the controller may be further configured to alter the data by one or more of: embedding one or more identifiers of the first client device into the altered data; embedding the one or more identifiers of the first client device into media identified by the altered data; embedding the one or more identifiers of the first client device into one or more of a name and a network address of the media identified by the altered data; changing a first pricing structure of the data to second pricing structure of the altered data, the second pricing structure identifying the first client device; changing an alphanumeric identifier associated with the provider object to identify the first client device; and adding text to the altered data that identifies the first client device.

At the second aspect, the controller may be further configured to determine the lack of association between the first client device and the second client device by using a memory storing associations between client devices.

At the second aspect, the controller may be further configured to determine the lack of association between the first client device and the second client device based on text of the altered data that identifies the first client device, the text associated with the first client device and not the second client device.

At the second aspect, the remedial action may comprise one or more of: invalidating the provider object; denying access to the provider object by one or more of the first client device and the second client device, and denial of the access to the provider object may occur temporarily or permanently; changing further provider objects associated with the first client device to respective provider objects associated with the second client device; changing prices or services of the further provider objects associated with the first client device to altered prices or altered services; and, one or more of initiating and applying a financial penalty against one or more of the first client device and the second client device.

At the second aspect, the controller may be further configured to: request the provider object from the second client device; receive a request for the provider object from the first client device, the provider object generated in response to the request; provide the altered provider object, including the altered data, to the first client device; and receive the altered data of the altered provider object from the second client device.

At the second aspect, the controller may be further configured to receive the altered data occurs as part of receiving scraped content associated with the second client device.

At the second aspect, the controller may be further configured to receive the altered data by receiving one or more of an image of the altered data and a scan of the altered data.

A third aspect of the present specification provides a non-transitory computer-readable medium storing a computer program, wherein execution of the computer program is to implement a method comprising: generating, via one or more computing devices, a provider object representing at least one item provided by a provider system, the provider object including data, the provider object associated with a request from a first client device; altering, via the one or more computing devices, the data to identify the provider object as being associated with the first client device, to generate an altered provider object comprising altered data that identifies the first client device; providing, via the one or more computing devices, the altered provider object to the first client device; receiving, via the one or more computing devices, the altered data of the altered provider object, the altered data being one or more of received from a second client device, captured at the second client device, and associated with the second client device; identifying, via the one or more computing devices, the first client device from the altered data; and in response to determining a lack of association between the first client device and the second client device, initiating a remedial action against one or more of the first client device and the second client device.

At the third aspect, altering the data may comprises one or more of: embedding one or more identifiers of the third client device into the altered data; embedding the one or more identifiers of the third client device into media identified by the altered data; embedding the one or more identifiers of the third client device into one or more of a name and a network address of the media identified by the altered data; changing a third pricing structure of the data to second pricing structure of the altered data, the second pricing structure identifying the third client device; changing an alphanumeric identifier associated with the provider object to identify the third client device; and adding text to the altered data that identifies the third client device.

At the third aspect, determining the lack of association between the third client device and the second client device may occur using a memory storing associations between client devices.

At the third aspect, determining the lack of association between the third client device and the second client device may be based on text of the altered data that identifies the third client device, the text associated with the third client device and not the second client device.

At the third aspect, the remedial action may comprise one or more of: invalidating the provider object; denying access to the provider object by one or more of the third client device and the second client device, and denial of the access to the provider object may occur temporarily or permanently; changing further provider objects associated with the third client device to respective provider objects associated with the second client device; changing prices or services of the further provider objects associated with the third client device to altered prices or altered services; and, one or more of initiating and applying a financial penalty against one or more of the first client device and the second client device.

At the third aspect, the method may further comprise: requesting, via the one or more computing devices, the provider object from the second client device; receiving, via the one or more computing devices, a request for the provider object from the third client device, the provider object generated in response to the request; providing, via the one or more computing devices, the altered provider object, including the altered data, to the third client device; and receiving, via the one or more computing devices, the altered data of the altered provider object from the second client device.

At the third aspect, receiving the altered data may occur as part of receiving scraped content associated with the second client device.

At the third aspect, receiving the altered data may occur by receiving one or more of an image of the altered data and a scan of the altered data.

A fourth aspect of the present specification provides a method comprising: generating, via one or more computing devices, a provider object representing at least one item provided by a provider system, the provider object associated with a request from a first client device; providing, via the one or more computing devices, the provider object to the first client device; receiving, via the one or more computing devices, data associated with the provider object, the data being one or more of received from one or more of the first client device, a second client device, captured at the second client device, and associated with the second client device; determining, via the one or more computing devices, that the data includes information identifying the first client device and the second client device; and, in response, initiating a remedial action against one or more of the first client device and the second client device.

At the fourth aspect, the method may further comprise: generating, via the one or more computing devices, a payment page that includes fields to identify the first client device and the second client device; and providing, via the one or more computing devices, the payment page to the first client device; receiving the data by receiving the payment page with the fields populated to identify the first client device and the second client device; and determining that the data includes information identifying the second client device and the first client device by determining that the payment page as received from the second client device identifies the first client device and the second client device.

At the fourth aspect, receiving the data may comprise receiving information from the first client device that identifies a payment account associated with the second client device, and determining that the data includes information identifying the second client device and the first client device may comprise determining that the payment account is associated with the second client device and not the first client device from which the data is received, the data including an identifier of the first client device.

A fifth aspect of the present specification provides a computing device comprising: a communication interface; and a controller configured to: generate a provider object representing at least one item provided by a provider system, the provider object associated with a request from a first client device; provide, via the communication interface, the provider object to the first client device; receive, via the communication interface, data associated with the provider object, the data being one or more of received from one or more of the first client device, a second client device, captured at the second client device, and associated with the second client device; determine that the data includes information identifying the first client device and the second client device; and, in response, initiate a remedial action against one or more of the first client device and the second client device.

At the fifth aspect, the controller may be further configured to: generate a payment page that includes fields to identify the first client device and the second client device; and provide the payment page to the first client device; receiving the data by receiving the payment page with the fields populated to identify the first client device and the second client device; and determine that the data includes information identifying the second client device and the first client device by determining that the payment page as received from the second client device identifies the first client device and the second client device.

At the fifth aspect, the controller may be further configured to: receive the data by receiving information from the first client device that identifies a payment account associated with the second client device; and determine that the data includes information identifying the second client device and the first client device by determining that the payment account is associated with the second client device and not the first client device from which the data is received, the data including an identifier of the first client device.

A sixth aspect of the present specification provides a non-transitory computer-readable medium storing a computer program, wherein execution of the computer program is to implement a method comprising: generating, via one or more computing devices, a provider object representing at least one item provided by a provider system, the provider object associated with a request from a first client device; providing, via the one or more computing devices, the provider object to the first client device; receiving, via the one or more computing devices, data associated with the provider object, the data being one or more of received from one or more of the first client device, a second client device, captured at the second client device, and associated with the second client device; determining, via the one or more computing devices, that the data includes information identifying the first client device and the second client device; and, in response, initiating a remedial action against one or more of the first client device and the second client device.

At the sixth aspect, the method may further comprise: generating, via the one or more computing devices, a payment page that includes fields to identify the first client device and the second client device; and providing, via the one or more computing devices, the payment page to the first client device; receiving the data by receiving the payment page with the fields populated to identify the first client device and the second client device; and determining that the data includes information identifying the second client device and the first client device by determining that the payment page as received from the second client device identifies the first client device and the second client device.

At the sixth aspect, receiving the data may comprise receiving information from the first client device that identifies a payment account associated with the second client device, and determining that the data includes information identifying the second client device and the first client device may comprise determining that the payment account is associated with the second client device and not the first client device from which the data is received, the data including an identifier of the first client device.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a system for initiating remedial actions based on altered provider objects, according to non-limiting examples.

FIG. 2 depicts an example computing device for initiating remedial actions based on altered provider objects, according to non-limiting examples.

FIG. 3 depicts a method for initiating remedial actions based on altered provider objects, according to non-limiting examples.

FIG. 4 depicts the system of FIG. 1 implementing a method for initiating remedial actions based on altered provider objects, according to non-limiting examples.

FIG. 5 depicts an altered provider object, according to non-limiting examples.

FIG. 6 depicts another altered provider object, according to non-limiting examples.

FIG. 7 depicts another altered provider object, according to non-limiting examples.

FIG. 8 depicts another altered provider object, according to non-limiting examples.

FIG. 9 depicts another altered provider object, according to non-limiting examples.

FIG. 10 depicts another altered provider object, according to non-limiting examples.

FIG. 11 depicts a method for initiating remedial actions based on data associated with a provider object, the data received from a first client device or a second client device, the first client device acting as a proxy for the second client device, according to non-limiting examples.

FIG. 12 depicts the system of FIG. 1 implementing a method for initiating remedial actions based on data received from a first client device acting as a proxy for a second client device, according to non-limiting examples.

FIG. 13 depicts examples of a payment page and payment information and payment information received from a first client device acting as a proxy for a second client device, the payment information used to initiate remedial actions, according to non-limiting examples.

### DETAILED DESCRIPTION

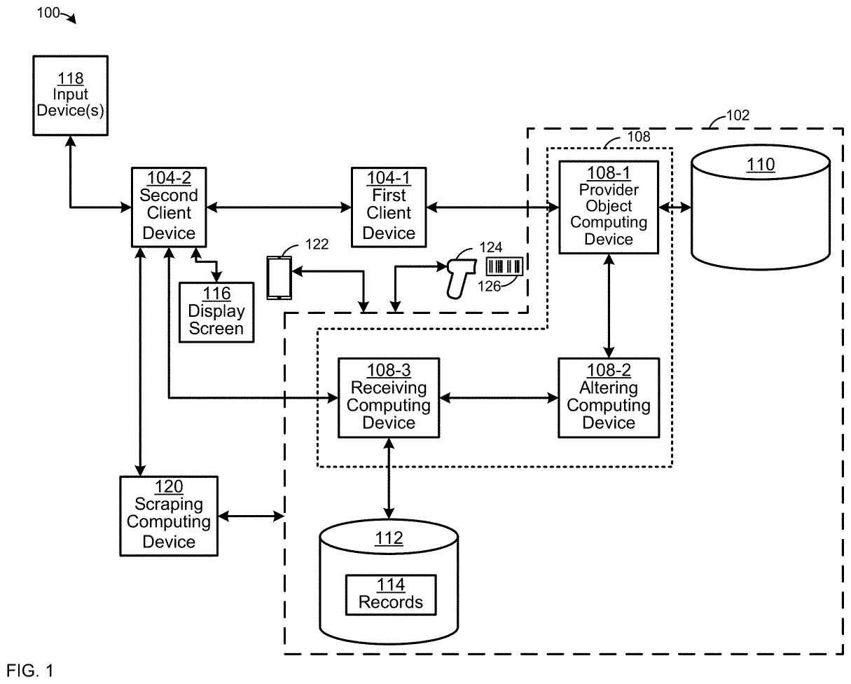

FIG. 1 depicts a system 100 for initiating remedial actions based on altered provider objects. The various components of the system 100 are understood to be in communication via any suitable combination of wired and/or wireless communication links. Communication links between components of the system 100 are depicted in FIG. 1, and throughout the present specification, are depicted as double-ended arrows between respective components; the communication links may include any suitable combination of wireless and/or wired links and/or wireless and/or wired communication networks, and the like.

Provider objects, in the examples discussed herein, may comprise provider objects and/or data records which correspond to products and/or items, such as travel-related goods and services (e.g. flights, hotel reservations, car rentals and the like), provided by a provider system. More specifically, the products and/or items discussed in the examples below may be flight tickets and related services (e.g. limo pickup services, excursions at a destination, baggage check services, in-flight food, entertainment, pet-related services, and the like). However, as will be apparent to those skilled in the art, the systems and methods discussed below can also be applied to various other types of data objects and/or items including, but not limited to, data objects correspond to any suitable products and/or any suitable items available (e.g. for purchase, and the like) from any suitable website, and the like.

Delivery of the items mentioned above is typically controlled by a provider entity, such as an airline in the case of the items discussed in connection with the examples provided herein. The system 100 includes one or more provider systems 102 (e.g. one or more servers or other suitable computing devices), which in this example is operated by one or more provider entities. The system 100 can include a plurality of provider systems 102, each operated by respective provider entities (e.g. various airlines), although only one provider system 102 is shown for illustrative purposes. As depicted, the system 100 includes a first client device 104-1, and second client device 104-2, although the system 100 may comprise further client devices. Hereafter, the first client device 104-1 and the second client device 104-2 will be interchangeably referred to, collectively, as the client devices 104 and, generically, as a client device 104.

Provider objects may be in any suitable format including, but not limited to Edifact recommendations in the context of Global Distribution System (GDS)-based data exchange, offer records in the context of New Distribution Capability (NDC)-based data exchange, and/or any other suitable format. Indeed, the provider objects may comprise data objects and/or data records, for example storing an Edifact recommendation or an NDC offer, and/or any other suitable data representing at least one item provided by the provider system 102.

A provider object is understood to define an item, or a combination of items, which may be offered for purchase (e.g. by end users of the items) including, but not limited to one or more of flights, train rides, hotel stays, airport lounge access, seat upgrades, baggage check services, in-flight food, entertainment, pickup services, excursion services, pet-related services, and the like, and/or associated services. Thus, in examples discussed below, a provider object may define a flight operated by the provider entity, and/or services associated with the flight, or proposed as standalone services. Each provider object therefore may contain various fields (e.g. data fields), and the like. Certain fields define item attributes, such as product object identifiers (e.g. service identifiers, item identifiers, product identifiers and the like), locations, dates and times corresponding to the products (e.g. flight times and other itinerary data). The type of fields and/or data of a provider object may depend on a type of a provider object. For example, provider objects corresponding to flights may include flight identifiers, whereas provider objects corresponding to other travel-related items, such as an offer for accessing an airport lounge and/or an offer for a premium seat upgrade, may include information related to the lounge, the premium seat, etc.

Requests for provider objects may be received at the provider system 102 from other components of the system 100. For example, the requests may be received from a client device 104 (e.g. via a network, not depicted, which may include any suitable combination of local and wide area networks, including the Internet).

In particular, as will be described herein, provider objects may be provided to the first client device 104-1; however, as described herein, receiving requests for a provider object, and/or requests to purchase a provider object that has been provided to the first client device 104-1, may be received from the second client device 104-2 via the first client device 104-1.

Put another way, a provider object (and/or an offer for a provider object) may be provided to the first client device 104-1, which may be acting as a proxy and/or surrogate for the second client device 104-2, and hence the first client device 104-1 may receive such a provider object and/or corresponding offer, and pass the provider object and/or corresponding offer to the second client device 104-2; the second client device 104-2 may initiate a purchase of the provider object represented by the provider object and/or corresponding offer. However, as the provider object and/or corresponding offer may be particular to, and/or customized for, the first client device 104-1, for example according to an agreement between an entity associated with the first client device 104-1 and an entity operating the provider system 102 (e.g. that indicates preferred pricing, special and/or preferred services, and the like), the first client device 104-1 acting a proxy and/or surrogate for the second client device 104-2 may enable the second client device 104-2 to take advantage of the agreement without entering into the agreement. Hereafter, the term “proxy” will be used, however, the term “surrogate” may be substituted for the term “proxy” where suitable.

As will be described below, the provider system 102 may generally comprise one or more computing devices 108, for example, as depicted, a provider object computing device 108-1, a provider object altering computing devices 108-2, and a receiving computing device 108-3. Such an architecture, however, is specifically according to certain functionalities provided by the computing devices 108, and hence it is understood that the system 100 and/or the provider system 102 may comprise any suitable number of one or more computing devices 108 for implementing functionality as described herein, with functionality therebetween distributed in any suitable manner. Hereafter, the provider object computing device 108-1, the altering computing devices 108-2, and the receiving computing device 108-3 will be interchangeably referred to, collectively, as the computing devices 108 and, generically, as a computing device 108.

As depicted, the provider system 102 further comprises a provider object database 110, as depicted in communication with the provider object computing device 108-1. The provider object database 110 may generally store provider objects (and/or offers thereof) provided to the first client device 104-1 (e.g. and/or other client devices 104). For example, the provider object computing device 108-1 may generate offers and/or associated provider objects and store such offers and/or associated provider objects at the provider object database 110. The provider object database 110 may further store orders for items represented by provider objects which may include, but is not limited to, requests to the receiving computing device 108-3 of the provider system 102 when ordering and/or booking items represented by provider objects.

In particular, as will be described below, the provider object computing device 108-1 may generate provider objects, and/or corresponding offers, for the first client device 104-1 and provide the provider objects, and/or corresponding offers to the altering computing device 108-2. The altering computing device 108-2 may alter data of the provider objects, and/or corresponding offers to identify the provider objects, and/or corresponding offers as being associated with the first client device 104-1, to generate altered provider objects, and/or altered corresponding offers, comprising altered data that identifies the first client device 104-1. Hereafter, for simplicity, and further to include provider objects generated according to the NDC standard and the GDS standard (e.g. offers may be particular to the NDC standard), reference will be made to generating provider objects and altering provider objects, which is understood to include, but is not limited to, generating offers of such provider objects and altering such offers of such provider objects.

While as depicted, the provider object database 110 is absent any offers and/or provider objects, such storage is described in more detail below.

As depicted, the provider system 102 further comprises an association database 112, as depicted in communication with the receiving computing device 108-3. The association database 112 may generally store associations between client devices 104, for example in the form of one or more records 114, and the like. For example, a record 114 may indicate that the first client device 104-1 and the second client device 104-2 are associated, such that offers and/or associated provider objects particular to, and/or customized for, the first client device 104-1, are also particular to, and/or customized for, the second client device 104-2 (e.g. in these examples, the second client device 104-2 may take advantage of any agreements between the entities associated with the first client device 104-1 and the provider system 102). However, in the absence of any record 114 indicating an association between the first client device 104-1 and the second client device 104-2, a lack of association between the first client device 104-1 and the second client device 104-2 may be determined (e.g., by the one or more computing devices 108) due to such an absence.

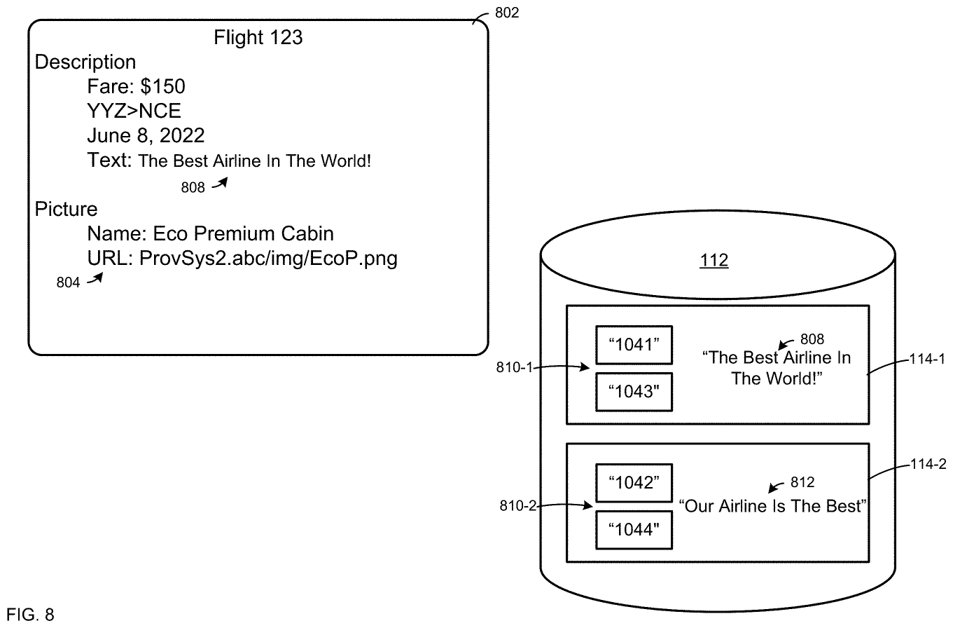

Alternatively, and/or in addition, the records 114 may store text that is associated with the first client device 104-1 and not the second client device 104-2, and which may be incorporated into altered data of the altered provider object. Such text may identify the first client device 104-1, and may comprise a textual phrase and, in particular, a textual natural language phrase. Such an example is described in more detail with reference to FIG. 8.

While not depicted, the system 100 may further comprise an intermediation server which may be configured to convert data between formats associated with provider systems 102 and the client devices 104. For example, different provider systems 102 may communicate and/or provide provider objects, and/or corresponding offers, according to different formats which may not be compatible with a format used by the client devices 104. As such, an intermediation server may convert data received in different formats from a provider system 102, to a format compatible with a client device 104, and vice versa. However it is understood that such an intermediation server may receive a request for a provider object from a client device 104 and communicate with a plurality of provider systems 102 to request such a provider object from the plurality of provider systems 102, aggregate responses of the plurality of provider systems 102 and provide the responses, as aggregated to the client device 104, the aggregated responses representing provider objects offered by the plurality of provider systems 102; the intermediation server may perform the aforementioned conversion between formats in these examples when suitable.

The client devices 104, in present examples, may be operated by respective travel agent entities, and therefore may generate and provide requests for provider objects (e.g. representing products which may be for purchase), and/or requests to purchase items (e.g. represented by the provider objects), to the provider system 102, on behalf of end users (e.g. travelers).

Various other mechanisms for initiating the creation of the provider objects are also contemplated. For example, end users (via the client device 104 and/or client devices and/or additional computing devices, not shown in FIG. 1) may initiate the creation of the provider objects via direct interaction with a website hosted by a client device 104, and the like. Various mechanisms for the creation of provider objects will be apparent to those skilled in the art, such as the “offer” and “order” mechanisms specified by the NDC standard. The creation of provider objects in response to product purchase requests is not discussed in further detail herein.

The client devices 104 are configured to receive, from the provider system 102, data contained in the provider objects. For example, data obtained by the second client device 104-2, for example from the provider object computing device 108-1 via the first client device 104-1, may be presented to a user served by the second client device 104-2, for example via a display screen 116 which may be local or remote to the second client device 104-2, and the user may interact with the second client device 104-2 via an input device 118 (e.g. one or more of a keyboard, a pointing device, and the like). Further information associated with the items represented by the provider objects may be requested by the second client device 104-2 which may include, but is not limited to the second client device 104-2 ordering the items. In other words, the system 100 enables the second client device 104-2 to request further information associated with the items represented by the provider objects which may include, but is not limited to, a finalized price for a provider object and/or an item represented by a provider object. The second client device 104-2 may be configured to request the further information and/or initiate orders and/or bookings for items represented by provider objects by providing requests to the receiving computing device 108-3 of the provider system 102.

The provider objects provided by the provider system 102 generally include provider object data representing at least one item provided by the provider system 102. In some examples, the provider object data may include a provider object identifier and/or provider object identifier data, that identifies the provider object to the provider system 102. In examples related to the travel industry, provider object data generally comprises information that identifies a travel related product and/or service. Whether the provider object data includes a specific provider object identifier, or not, may depend on whether a provider object is in an NDC format or a GDS format. For example, when a provider object comprises an NDC offer, the provider object identifier data may comprise an identifier generated by the provider system 102, which specifically identifies the NDC offer. However, when a provider object comprises an Edifact recommendation (e.g. a GDS format), which generally does not include a specific identifier, the Edifact recommendation may be identified by the provider system 102 based on provider object identifier data such as characteristics of the Edifact recommendation such as a specific order and/or format of data of the Edifact recommendation.

It is further understood that, in some examples, components of the system 100 may operate according to NDC standard and/or the GDS standard.

As depicted, the system 100 may further comprise a data scraping computing device 120 in communication with the provider system 102 (e.g. any suitable combination of the one or more computing devices 108) and the second client device 104-2, which may scrape data generated at the second client device 104-2 (and/or any suitable client device 104), and provide such scraped data to the provider system 102.

As depicted, the system 100 may further comprise an image capture device 122, for example, as depicted, a mobile phone equipped with a camera, in communication with the provider system 102 (e.g. any suitable combination of the one or more computing devices 108). The image capture device 122 may be in a location, relative to the display screen 116 associated with the second client device 104-2, to capture and/or acquire an image of the display screen 116, for example at which altered data of an altered provider object may be being provided and/or rendered. The image capture device 122 may provide such an image of the altered data (e.g. as rendered at the display screen 116) to the provider system 102 (e.g. any suitable combination of the one or more computing devices 108). In particular, a customer of a travel agent operating the second client device 104-2 may operate the image capture device 122 to acquire such images, and/or an entity associated with the provider system 102 may send an employee, and the like, undercover to the travel agent with the image capture device 122 to acquire such images. It is further understood that the image capture device 122 may alternatively capture images of printed documents that include the altered data (e.g. rather than images of altered data at a display screen).

As depicted, the system 100 may further comprise a scanner 124, for example, as depicted, a handheld barcode scanner (e.g. and/or QR (quick response) code scanner), and the like, in communication with the provider system 102 (e.g. any suitable combination of the one or more computing devices 108). The scanner 124 may be in a location (e.g. such as an airport, and the like) to scan a code 126 (e.g. a bar code, QR code, and the like) of a boarding pass (e.g. which may be in a paper or electronic format), and the like, the code 126 representing the altered data. For example, the altered data may be incorporated into a boarding pass, and the like, associated with boarding a flight represented by the original provider object, and the scanner 124 may scan the code 126 and provide the altered data to the provider system 102 (e.g. any suitable combination of the one or more computing devices 108). Alternatively, the image capture device 122 may capture images of a document on which the code 126 is printed, and which may include any suitable altered data (e.g. such as a logo associated with the second client device 104-2, as described in more detail below).

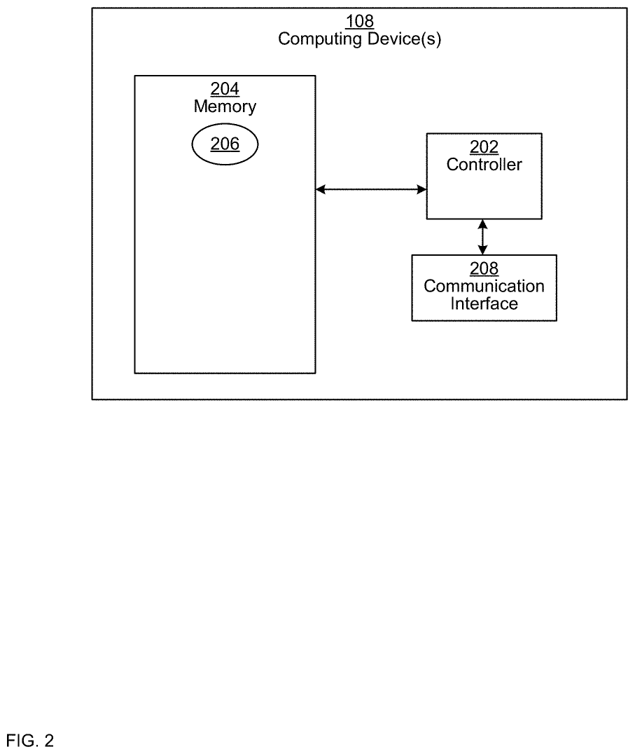

Turning to FIG. 2, before discussing the functionality of the system 100 in greater detail, certain components of a computing device 108, of the one or more computing devices 108, will be discussed in greater detail. While depicted in FIG. 2 as one device, the depicted computing device 108 may comprise one or more computing devices and/or one or more servers and/or one or more cloud computing devices that may be geographically distributed.

As shown in FIG. 2, the computing device 108 includes at least one controller 202, such as a central processing unit (CPU) or the like. The controller 202 is interconnected with a memory 204 storing an application 206, the memory 204 implemented as a suitable non-transitory computer-readable medium (e.g. a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The controller 202 and the memory 204 are generally comprised of one or more integrated circuits (ICs).

The controller 202 is also interconnected with a communication interface 208, which enables the one or more computing devices 108 to communicate with the other components of the system 100 (i.e. other computing devices 108 and the client devices 104) for example via a network, though it is understood such communication may occur locally when one or more computing devices 108 are combined. The communication interface 208 therefore may include any necessary components (e.g. network interface controllers (NICs), radio units, and the like) to communicate via a network. The specific components of the communication interface 208 may be selected based on upon the nature of network and/or local communication between components of the system 100, and the like. The computing device 108 may also include input and output devices connected to the controller 202, such as keyboards, pointing devices, displays, and the like (not shown).

The components of the computing device 108 mentioned above can be deployed in a single enclosure, or in a distributed format. In some examples, therefore, the computing device 108 may include a plurality of processors, either sharing the memory 204 and communication interface 208, or each having distinct associated memories and communication interfaces. As such, it is understood that the memory 204, and/or a portion of the memory 204, may be internal (e.g. as depicted) or external to the computing device 108; regardless, the controller 202 is understood to have access to the memory 204.

The memory 204 generally stores a plurality of computer-readable programming instructions, executable by the controller 202, in the form of various applications, including the application 206. As will be understood by those skilled in the art, the controller 202 executes the instructions of the application 206 (and any other suitable applications) in order to perform various actions defined by the instructions contained therein. In the description below, the controller 202, and more generally the computing device 108 (and/or the one or more computing devices 108), are understood to be configured to perform those actions. It will be understood that they are so configured via the execution (by the controller 202) of the instructions of the applications (e.g. the application 206) stored at the memory 204.

While not depicted, the memory 204 may store one or more of the databases 110, 112, and/or portions thereof. Alternatively, one or more of the databases 110, 112, and/or portions thereof, may be implemented at other computing devices (not depicted) of the provider system 102, which may be dedicated to maintaining one or more of the databases 110, 112.

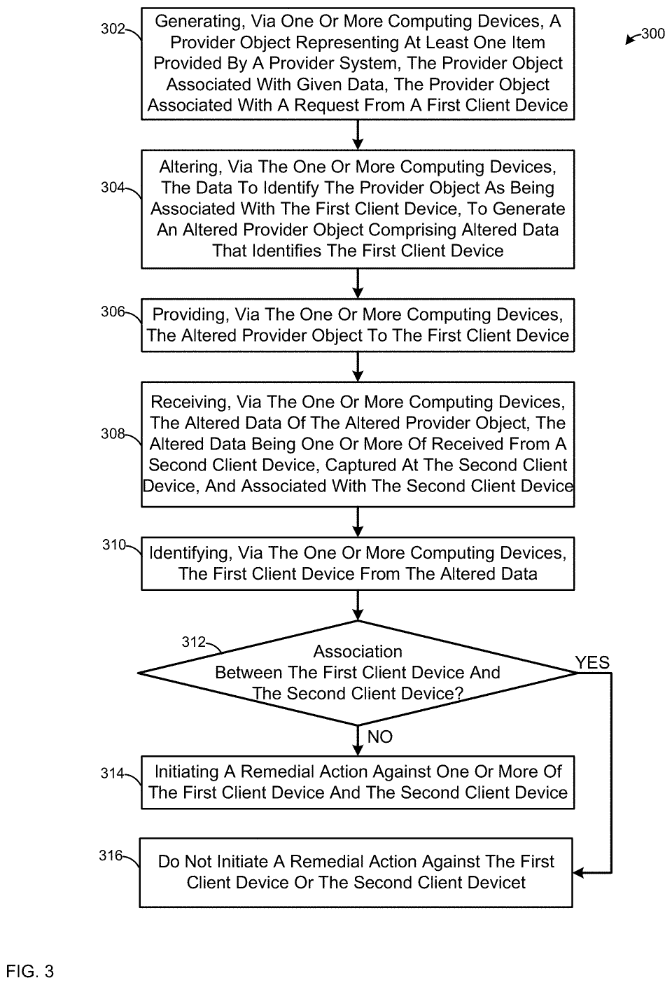

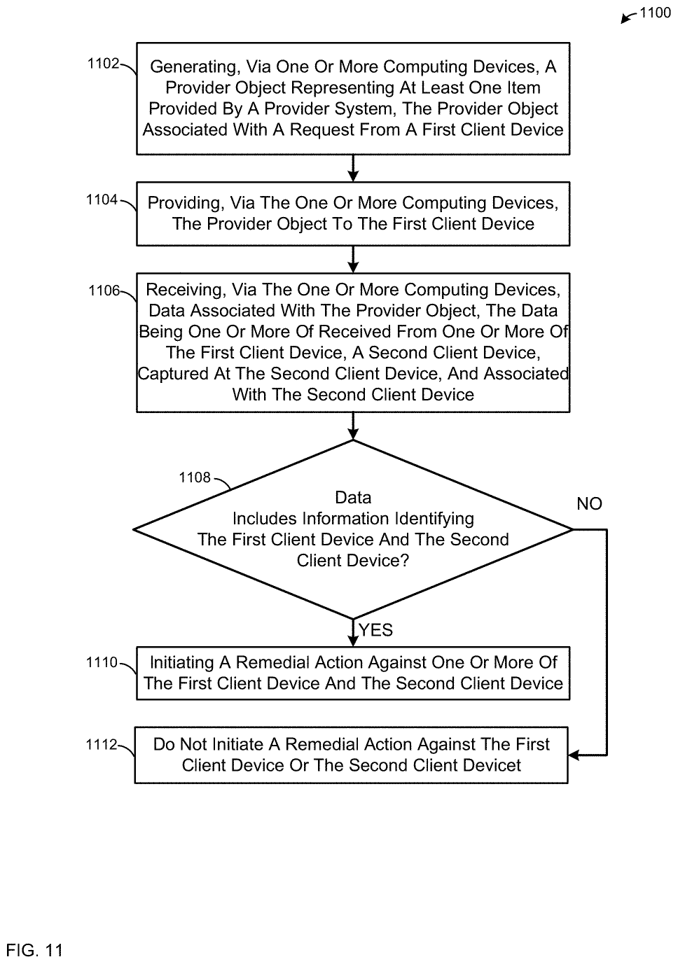

In some examples, execution of the application 206, as will be discussed below, configures the computing device 108 to implement functionality for initiating remedial actions based on altered provider objects, including but not limited to, the blocks of a method set forth in FIG. 3. In yet further examples, execution of the application 206, as will be discussed below, configures the computing device 108 to implement functionality for initiating remedial actions based on data associated with a provider object, the data received from a first client device or a second client device, the first client device acting as a proxy for the second client device, including but not limited to, the blocks of a method set forth in FIG. 11. In some examples, the application 206 may include modules for implementing different functionality.

While structure of the client devices 104 are not described in detail, the client devices 104 are understood to have a similar structure as the computing device 108, but adapted for the functionality of the provider system 102 and the client devices 104.

Attention is now directed to FIG. 3, which depicts a flowchart representative of a method 300 a method for initiating remedial actions based on altered provider objects. The operations of the method 300 of FIG. 3 correspond to machine readable instructions that are executed by the one or more computing devices 108, for example by a controller 202 of the one or more computing devices 108. In the illustrated example, the instructions represented by the blocks of FIG. 3 are stored at the memory 204 for example, as the application 206. The method 300 of FIG. 3 is one way in which the controller 202 and/or the one or more computing devices 108 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

At a block 302, the controller 202 and/or the one more computing devices 108 generates a provider object representing at least one item provided by the provider system 102, the provider object including data, the provider object associated with a request from the first client device 104-1. For example, the block 302 may be implemented by the provider object computing device 108-1.

In some examples, the provider object may be generated upon receiving a request for the provider object from the first client device 104-1. For example, the receiving computing device 108-3 may request a provider object from the second client device 104-2, and the second client device 104-2 may use the first client device 104-1 as a proxy to cause the first client device 104-1 to request the provider object from the provider system 102 (e.g. via a request for the provider object provided to the provider object computing device 108-1). The provider object computing device 108-1 may receive the request and generate the provider object. Hence, in these examples, the receiving computing device 108-3 mimics being a user of the second client device 104-2 in order to track where requests for provider objects may be originating.

However, the provider object may be generated under any suitable conditions. For example, the first client device 104-1 may request the provider object from the first client device 104-1 as part of a volume transaction in which many provider objects are requested at a time (e.g. for popular flights, using a travel industry example) so that the first client device 104-1 has rapid access to provider objects when requested, such as when requested by the second client device 104-2. In these examples, the second client device 104-2 may be operated by any suitable user.

At a block 304, the controller 202 and/or the one more computing devices 108 alters the data to identify the provider object as being associated with the first client device 104-1, to generate an altered provider object comprising altered data that identifies the first client device 104-1. For example, the block 304 may be implemented by the altering computing device 108-2, and it is understood that the provider object computing device 108-1 may provide the generated provider object to the altering computing device 108-2.

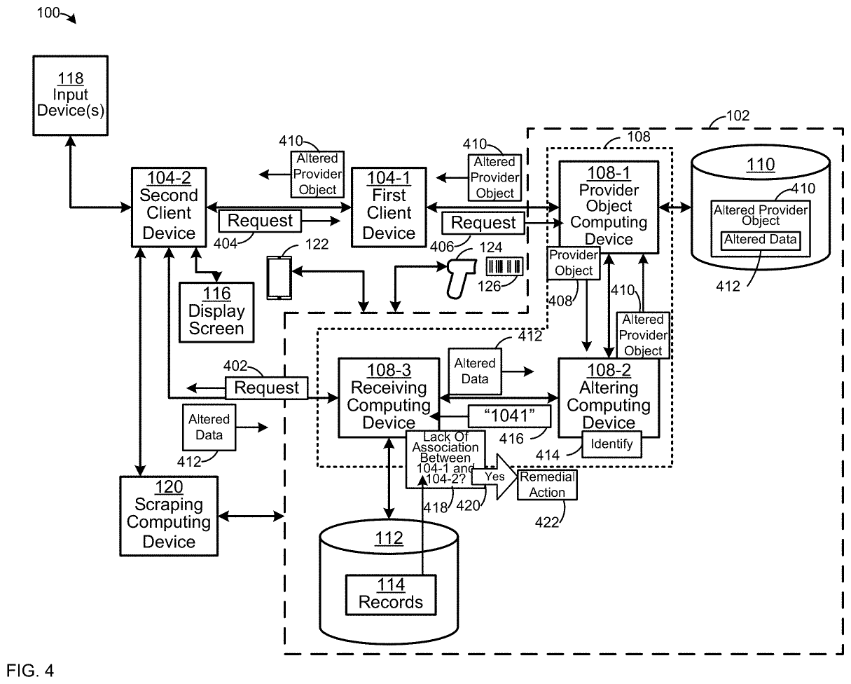

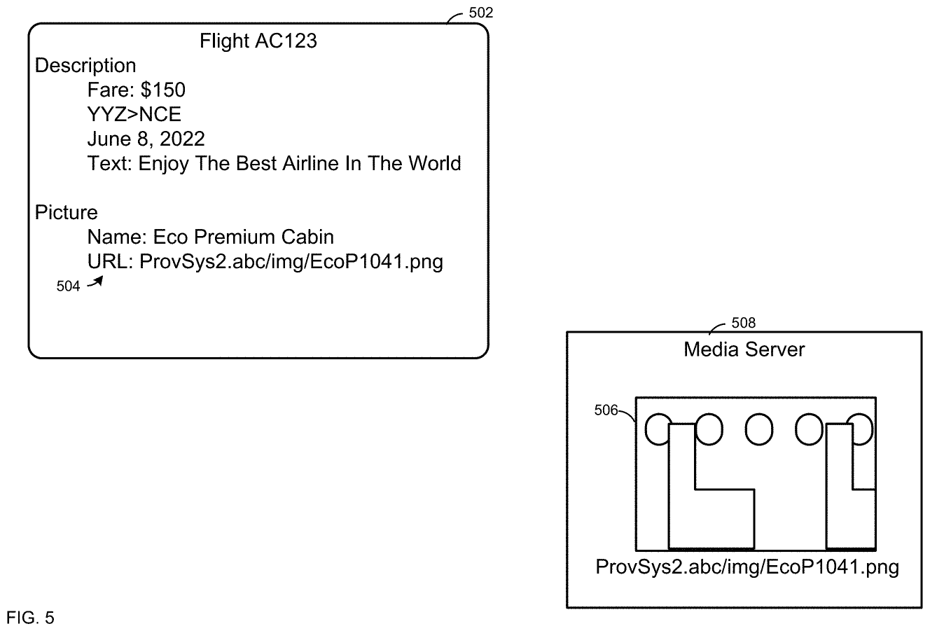

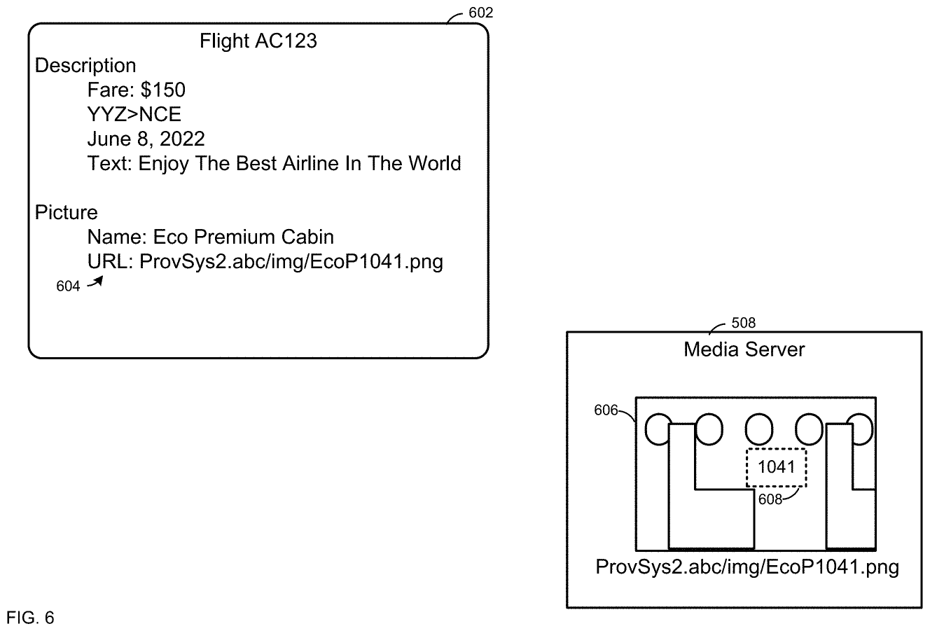

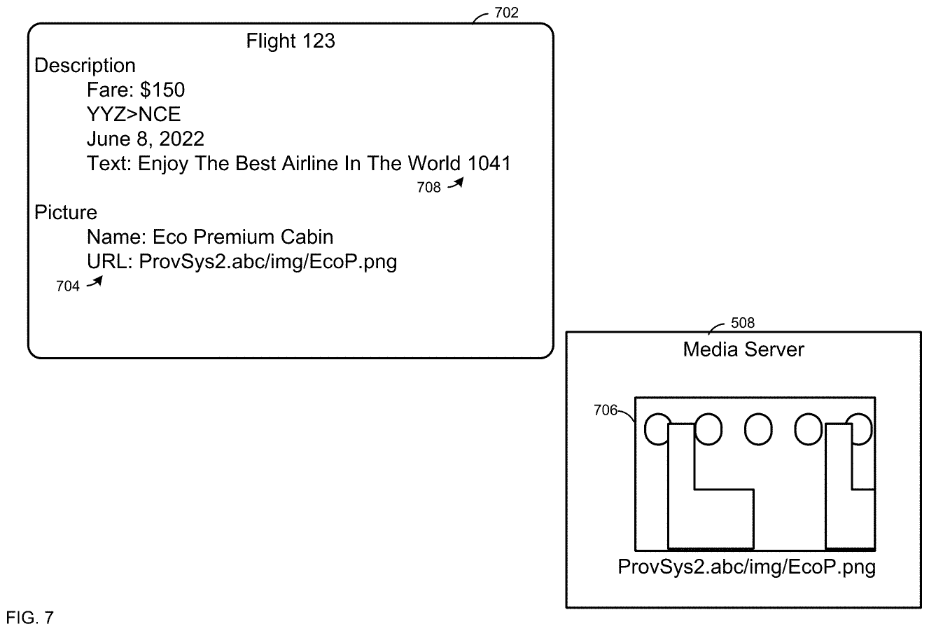

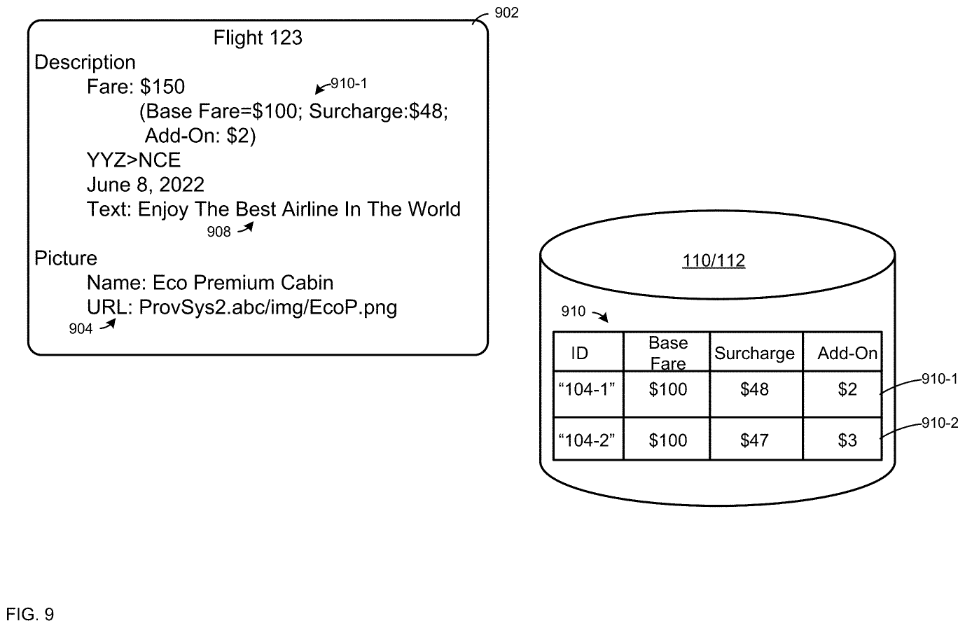

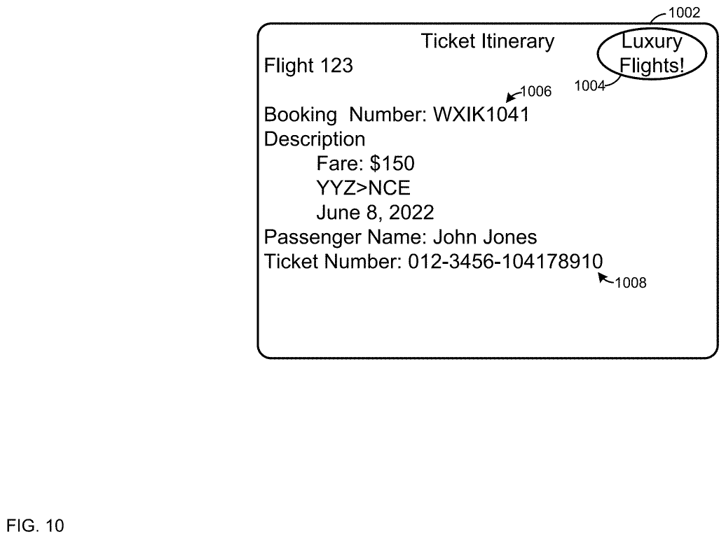

While types of data of provider objects that may be altered may include any suitable data, and details of such data and corresponding altering are described below with respect to FIG. 4, FIG. 5, FIG. 6, FIG. 7, FIG. 8, FIG. 9 and FIG. 10. In particular examples, it is understood that altering the data may include, but is not limited to, one or more of:
Embedding one or more identifiers of the first client device 104-1 into the altered data. For example, the altering computing device 108-2 may generate any suitable alphanumeric identifier, and the like, that may be associated with the first client device 104-1 and embed the identifier into a field of the provider object that may be provided at the display screen 116 of the second client device 104-2 and/or in metadata of the provider object and/or in media (e.g. images, video, audio, and the like) associated with the provider object, a Uniform Resource Locator (URL) of the media, and/or in any other suitable manner.
Embedding the one or more identifiers of the first client device 104-1 into media identified by the altered data. For example, the one or more identifiers of the first client device 104-1 may be embedded into an image and/or video using steganography techniques, and the like, and or as sound into audio.
Embedding the one or more identifiers of the first client device 104-1 into one or more of a name and a network address of the media identified by the altered data. For example, media of the provider object may be stored at a server (not depicted) and/or one or more of the computing devices 108 and/or one or more of the databases 110, 112 associated with the provider system 102, and a name and/or network address (e.g. a URL thereof) of the media may be a component of the provider object; in these examples, the name and/or network address of the media may be altered at the provider object (e.g. and as stored at the provider system 102) to include the one or more identifiers of the first client device 104-1
Changing a first pricing structure of the data to second pricing structure of the altered data, the second pricing structure identifying the first client device 104-1. For example, a price of a provider object may be structured in different ways to arrive at a given total price, in form of a base price and different combinations of surcharges and/or add-on charges (e.g. a baggage charge, a lounge charge, and the like). Such a price structure may be altered to identify the first client device 104-1.
Changing an alphanumeric identifier associated with the provider object to identify the first client device 104-1. For example, with reference to the travel industry, an alphanumeric identifier booking reference number of a flight, and the like, may be altered to incorporate a reference number associated with the first client device 104-1. However, in other examples pertaining to the travel industry, one or more of a passenger name record (PNR), an order identifier (e.g. an “OrderID” in NDC-based examples), a ticket number, an electronic miscellaneous document (EMD) number, a check-in number, the aforementioned booking reference number, and the like, may be altered to identify the first client device 104-1.
Adding text to the altered data that identifies the first client device 104-1, for example text stored in the records 114.

In some examples, an identifier of the first client device 104-1 that is incorporated into the altered data may be predetermined, however, in other examples, an identifier of the first client device 104-1 that is incorporated into the altered data may be generated in response to generating the provider object, and/or at any other suitable time. In examples where an identifier of the first client device 104-1 is generated, the identifier may be randomly (and/or pseudo-randomly) generated using a random number generator, and the like, that be component of the application 206, and/or may comprise a separate module stored at the memory 204.

Furthermore, it is understood that, when the altered data that identifies the first client device 104-1 is generated, the altered data (e.g. and any identifier of the first client device 104-1) may be stored at the provider object database 110, for example in the form of the altered provider object. In particular, the altered data and/or the altered provider object may be stored with the identifier of the first client device 104-1 that is incorporated into the altered data and/or any other suitable identifier of the first client device 104-1. For example, when the identifier of the first client device 104-1 that is incorporated into the altered data is a random number, and the like, the altered data and/or the altered provider object may be stored at the provider object database 110 in association with a persistent identifier of the first client device 104-1, such as a natural language identifier, and/or a registration name and/or number of the first client device 104-1, and the like. In the latter example, it is understood that the first client device 104-1 may register with the provider system 102, which may issue a registration name and/or number to the first client device 104-1, and the like (e.g. as part of the aforementioned agreement between entities associated with the provider system 102 and the first client device 104-1). Such registration occurs such that the first client device 104-1 may request provider objects from the provider system 102, and purchase items corresponding to such provider objects. Such registration may further include registration of payment accounts, such as credit card numbers, bank account numbers, e-payment transfer accounts, and the like.

Regardless, it is understood that, the altered data may be used to identify the first client device 104-1. In some examples, as will be described below with respect to FIG. 8, the altered data may be used to identify client devices 104 that are associated with each other (e.g. clustered together).

At a block 306, the controller 202 and/or the one more computing devices 108 provides the altered provider object to the first client device 104-1. For example, the block 302 may be implemented by the provider object computing device 108-1, and it is understood that the altering computing device 108-2 may provide the altered provider object to the provider object computing device 108-1.

At the block 306, it is understood that the altered provider object may be stored at the provider object database 110. The original, unaltered provider object may be optionally stored at the provider object database. 110

It is further understood that the altered provider object, as provided to the first client device 104-1, is generally identifiable via an identifier, and the like, which may be provided in metadata of the altered provider object, and/or at one or more fields of the altered provider object, and/or the aforementioned altered data of the altered provider object, and the like.

At a block 308, the controller 202 and/or the one more computing devices 108 receives the altered data of the altered provider object, the altered data being one or more of received from a second client device 104-2, captured at the second client device 104-2, and associated with the second client device 104-2.

In examples where the receiving computing device 108-3 requested the provider object from the second client device 104-2, the second client device 104-2 may return the altered provider object to the receiving computing device 108-3, which receives the altered provider object at the block 308. Put another way, in these examples, the receiving computing device 108-3 requests a provider object from the second client device 104-2, which uses the first client device 104-1 as a proxy to obtain the altered provider object from the provider system 102, and the second client device 104-2 returns the altered provider object to the provider system 102 via the receiving computing device 108-3, which, as described in more detail below, may process the altered data of the altered provider object to determine whether, or not, the second client device 104-2 is using the first client device 104-1 as a proxy to request provider objects from the provider system 102.

Put another way, in some examples, the method 300 may further comprise: requesting (e.g. prior to the block 302), via the controller 202 and/or the one more computing devices 108, the provider object from the second client device 104-2; receiving (e.g. prior to the block 302), via the controller 202 and/or the one more computing devices 108, a request for the provider object from the first client device 104-1, the provider object generated in response to the request; providing (e.g. at the block 306), via the controller 202 and/or the one more computing devices 108, the altered provider object, including the altered data, to the first client device 104-1; and receiving (e.g. at the block 308), the controller 202 and/or the one more computing devices 108, the altered data of the altered provider object from the second client device 104-2.

However, the altered data of the provider object may be received in any suitable manner.

For example, the altered data may be received as scraped content, as scraped from the second client device 104-2 by the data scraping computing device 120. In particular, the data scraping computing device 120 may interact with the second client device 104-2 to initiate the second client device 104-2 requesting a provider object from the provider system 102 via the first client device 104-1, scrape content associated with the altered provider object from the second client device 104-2, including the altered data, and provide the altered data to the one or more computing devices 108. Indeed, the data scraping computing device 120 may scrape content from any suitable number of client devices 104 (e.g. tens, hundreds, thousands, and the like, of client devices 104) and provide the altered data to the one or more computing devices 108 as part of larger amount of scraped content. Indeed, in these examples, receiving the altered data at the block 308 may occur as part of receiving scraped content associated with the second client device 104-2.

In other examples, the altered data may be received as an image and/or images as acquired by the image capture device 122. In further examples, examples, the altered data may be received as a scan and/or scans as acquired by the scanner 124. Put another way, receiving the altered data, at the block 308, may occur by receiving one or more of an image of the altered data and a scan of the altered data. An image of the altered data may be captured at the second client device 104-2, and/or an image and/or scan of the altered data may be associated with the second client device 104-2. For example, an image of the altered data may be traceable back to having been captured at the second client device 104-2 (e.g. in a message that identifies the second client device 104-2) and/or the image of the altered data may include data that enables the one or more computing devices 108 to identify an entity associated with the second client device 104-2, such as a logo associated with the entity that is also rendered at the display screen 116 with the altered data. Similarly, a scan of the code 126 of the altered data may be traceable back to a ticket that was paid for by an entity associated with the second client device 104-2 (e.g. as indicated by an account associated with the second client device 104-2).

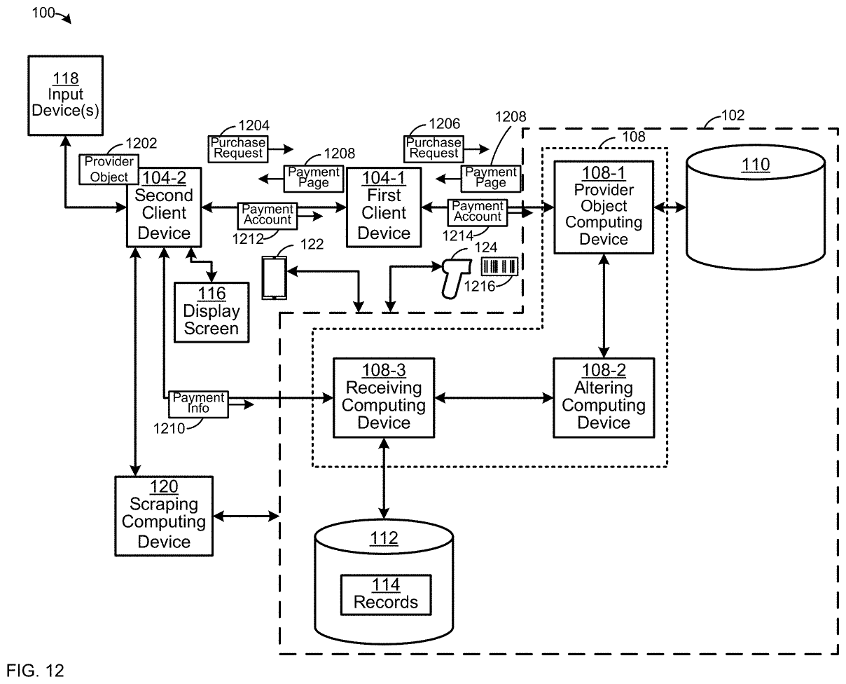

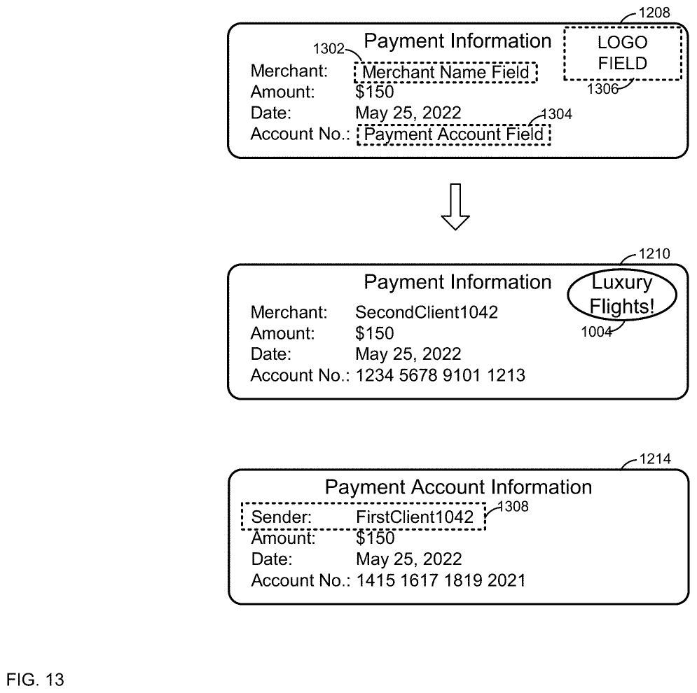

It is understood that, in some of these examples, the application 206 may include components for identifying logos, and the like, of an entity associated with the second client device 104-2, which may include, but is not limited to, image analysis components, and which may include one or more machine learning algorithms. Similarly, it is understood that, in some of these examples, the application 206 may include components for tracing an image of the altered data and/or scan of the altered data back to the second client device 104-2, and/or for determining an account that paid for the provider object as well as an association of such an account with the second client device 104-2 and/or an associated entity, for example as described below with respect to FIG. 10 and FIG. 13. Indeed, many entities that provide services for selling provider objects register with provider systems selling the provider objects; hence, the controller 202 and/or the one or more computing devices 108 may generally have access to such information. Indeed, it is further understood that both the first client device 104-1 and the second client device 104-2 may both generally register with the provider system 102, for example to request provider objects (e.g. and purchase corresponding items); for example, the second client device 104-2 may generally register with the provider system 102 to request provider objects (e.g. and purchase corresponding items) from the provider system 102 when not using the first client device 104-1 as a proxy. However, it is understood that when the second client device 104-2 attempts to pay for a provider object that has been received via the first client device 104-1, the second client device 104-2 generally continues to use the first client device 104-1 as a proxy to pay for the provider object (e.g. as described below with respect to FIG. 10, FIG. 11, FIG. 12, and FIG. 13.

However, the altered data may be received at the controller 202 and/or the one or more computing devices 108 in any suitable manner. For example, one or more of the first client device 104-1 and the second client device 104-2 may maintain a respective cache of altered provider objects and/or altered data, which may be returned to the controller 202 and/or the one or more computing devices 108 at any suitable time and in any suitable manner (e.g. in a batch submission of altered provider objects and/or altered data, and the like).

At a block 310, the controller 202 and/or the one more computing devices 108 identifies the first client device 104-1 from the altered data.

For example, as described above, the altered data generated at the block 304 may be stored at the provider object database 110, and the altered data received at the controller 202 and/or the one more computing devices 108 at the block 308 may be compared with the altered data stored at the provider object database 110 to identify the first client device 104-1.

At a block 312, the controller 202 and/or the one more computing devices 108 determines whether there is an association, or a lack of association, between the first client device 104-1 and the second client device 104-2.

For example, the controller 202 and/or the one more computing devices 108 may process the records 114 stored at the association database 112 to determine whether there is any stored association between the first client device 104-1 and the second client device 104-2. Put another way, determining the lack of association between the first client device 104-1 and the second client device 104-2 may occur using a memory (e.g. the database 112) storing associations between client devices 104).

Alternatively, determining a lack of association between the first client device 104-1 and the second client device 104-2 may be based on text of the altered data that identifies the first client device 104-1, the text associated with the first client device 104-1 and not the second client device 104-2. For example, the text may comprise a textual phrase, and the like, which may be associated with the first client device 104-1 and not the second client device 104-2, as stored in the records 114. An example is described with respect to FIG. 8.

In response to determining a lack of association between the first client device 104-1 and the second client device 104-2 (e.g. a “NO” decision at the block 312), at a block 314, the controller 202 and/or the one more computing devices 108 initiates a remedial action against one or more of the first client device 104-1 and the second client device 104-2.

In particular a remedial action may be initiated as, due to the lack of association between the first client device 104-1 and the second client device 104-2, the controller 202 and/or the one more computing devices 108 may determine that the first client device 104-1 is being used a proxy for the second client device 104-2, which may violate terms of the aforementioned agreement between entities associated with the first client device 104-1 and the provider system 102. For example, as previously described, the provider object may have been generated according to the terms of such an agreement and may have included preferred pricing, preferred services, and the like that is not otherwise available to the second client device 104-2.

For example, the remedial action may include, but is not limited to, one or more of:
Invalidating the provider object (and/or the altered provider object), for example, such that the provider object, and corresponding items, may not be purchased, and the like, via the second client device 104-2.
Denying access to the provider object (and/or the altered provider object) by one or more of the first client device 104-1 and the second client device 104-2, the denial of the access to the provider object (and/or the altered provider object) occurring temporarily or permanently. For example, the provider object may comprise a provider object that had been previously provided to the first client device 104-1, and a user of the first client device 104-1 may attempt to purchase item represented by the provider object, and the like. However, due to violation of the aforementioned agreement, access to the provider object by both the first client device 104-1 and the second client device 104-2 may be denied, for example permanently and/or for a time period determined by the provider system 102 and/or an associated entity (e.g. to allow for time for the entities associated with the first client device 104-1 and the provider system 102) to address the violation of the aforementioned agreement
Changing further provider objects associated with the first client device 104-1 to respective provider objects associated with the second client device 104-2. For example, as the controller 202 and/or the one or more computing devices 108 have determined that the second client device 104-2, not associated with the first client device 104-1, is attempting to access provider objects via the first client device 104-1, further provider objects associated with the first client device 104-1 may be changed to respective provider objects associated with the second client device 104-2, for example to remove preferred pricing and/or services and the like, and/or to change pricing and/or services to pricing and/or services defined by an agreement between entities associated with the second client device 104-2 and the provider system 102.
Changing prices or services of the further provider objects associated with the first client device 104-1 to altered prices or altered services, for example, to prices and/or services associated with the second client device 104-2.
One or more of initiating and applying a financial penalty against one or more of the first client device 104-1 and the second client device 104-2. For example, the provider system 102 (e.g. one or more of the computing device 108), and/or an entity thereof, may apply a commercial claim and/or penalty to one or more of the first client device 104-1 and the second client device 104-2, and/or my initiate such a commercial claim and/or penalty against respective associated entities. Such a commercial claim and/or penalty may include, but is not limited to, an Agent Debit Memo (ADM), a deduction on airline commissions, and the like.

However, any suitable remedial action may be implemented. For example, the aforementioned agreement between the entities associated with the first client device 104-1 and the provider system 102 may set out remedial actions that may occur when the agreement is violated, and any such suitable remedial actions may be implemented.

Returning to the block 312, in response to determining an association between the first client device 104-1 and the second client device 104-2 (e.g. a “YES” decision at the block 312), at a block 316, the controller 202 and/or the one more computing devices 108 does not initiate a remedial action against the first client device 104-1 or the second client device 104-2. In some of these examples, purchase of the of an item represented by the provider object, if and/or when initiated by the second client device 104-2, may occur.

In some examples, regardless of whether a “YES” decision or a “NO” decision occurs at the block 312, the controller 202 and/or the one more computing devices 108 may log activity associated with the block 314 or the block 316 (e.g. depending whether a “YES” decision or a “NO” decision occurs at the block 312) in a memory, and the like, for example, at the database 112 and/or any other suitable memory. Such logging of activity may be used to generate statistics and/or reports regarding the implementation of the method 300.

Attention is next directed to FIG. 4, FIG. 5, FIG. 6, FIG. 7, FIG. 8, FIG. 9 and FIG. 10, which depict examples of aspects of the method 300. In particular, FIG. 4 is substantially similar to FIG. 1, with like components having like numbers.

As depicted in the example of FIG. 4, the receiving computing device 108-3 may initiates the method 300 by transmitting a request 402 for a provider object to the second client device 104-2. The request 402 may include, but is not limited to, an interaction with a website operated by the second client device 104-2 to search for a flight, and the like, according to a set of parameters, such as an origin airport, a destination airport, and dates such as a departure date, and a return date, and the like. However, the request 402 may be for any given product, such as a physical item that may be purchased via a website operated by the second client device 104-2.

The second client device 104-2 receives the request 402 and, rather than communicate directly with the provider system 102, the second client device 104-2 transmits a corresponding request 404 to the first client device 104-1. The first client device 104-1 receives the request 404, and generates and transmits a corresponding request 406 to the provider object computing device 108-1. The corresponding request 406 may have information identifying the second client device 104-2 removed, and replaced by information identifying the first client device 104-1. Regardless, the corresponding request 406 is understood to be identifiable by the provider system 102 (e.g. the provider object computing device 108-1 and/or the altering computing device 108-2, and/or any other suitable computing device 108) as having been received from the first client device 104-1 (e.g. and not the second client device 104-2).

The provider object computing device 108-1 receives the corresponding request 406 and generates (e.g. at the block 302 of the method 300), a provider object 408, for example according to the set of parameters of the original request 402. For example, the provider object 408 may represent a flight that matches the set of parameters of the original request 402. While only one provider object 408 is depicted, the provider object computing device 108-1 may generate a plurality of provider objects (e.g. corresponding to a plurality of flights that match the set of parameters of the original request 402).

As depicted, the provider object computing device 108-1 provides the provider object 408 to the altering computing device 108-2, which alters (e.g. at the block 304 of the method 300) data of the provider object 408 to generate an altered provider object 410 that includes altered data 412, which identifies the first client device 104-1; for example, the altered data 412 may include an identifier of the first client device 104-1. Examples of the altered data 412 are described below with respect to FIG. 5, FIG. 6, FIG. 7, FIG. 8, FIG. 9 and FIG. 10. The altering computing device 108-2 provides the altered provider object 410 to the provider object computing device 108-1, which stores the altered provider object 410 with the altered data 412 at the provider object database 110; while not depicted, the altered provider object 410 may be stored with data that identifies the first client device 104-1. The provider object computing device 108-1 provides (e.g. at the block 306 of the method 300) the altered provider object 410 to the first client device 104-1, which provides the altered provider object 410 to the second client device 104-2.

As depicted in FIG. 4, the second client device 104-2 provides at least the altered data 412 of the altered provider object 410 to the receiving computing device 108-3, for example as response to the request 402; while not depicted, the altered data 412 may be provided to the receiving computing device 108-3 in the form of the altered provider object 410. The receiving computing device 108-3 hence receives (e.g. at the block 308 of the method 300) the altered data 412 and provides the altered data 412 to the altering computing device 108-2 for analysis, for example to determine whether the altered data 412 includes an identifier of the first client device 104-1. For example, the altering computing device 108-2 may extract the identifier of the first client device 104-1 that the altering computing device 108-2 included in the altered provider object 410 when the provider object 408 was received.

Regardless, as depicted, the first client device 104-1 may perform a process 414 to identify (e.g. at the block 310 of the method 300) the first client device 104-1 from the altered data 412, and return an identifier 416 (e.g., as depicted “1041” of the first client device 104-1 to the receiving computing device 108-3. The receiving computing device 108-3 may retrieve the records 114 to determine (e.g. at the block 312 of the method 300) whether there is a lack of an association 418 between the first client device 104-1 and the second client device 104-2 from which the altered data 412 was received. It is understood that the receiving computing device 108-3 has access to a respective identifier of the second client device 104-2, for example at least by virtue of communicating with the second client device 104-2 (e.g. when transmitting the request 402 and receiving the altered data 412).

As depicted, it is understood that the receiving computing device 108-3 has determined 420 that there is a lack of association (e.g. a “YES” decision at the block 312 of the method 300) between the first client device 104-1 and the second client device 104-2, and responsively initiates (e.g. at the block 314 of the method 300) a remedial action 422 as described above. In particular, the remedial action 422 is initiated as the records 114 are understood to indicate that the second client device 104-2 is not included in the aforementioned agreement between the entities associated with the first client device 104-1 and the provider system 102.

Attention is next directed to FIG. 5, which depicts an example of an altered provider object 502 that has been altered (e.g. at the block 304 of the method 300) to include an identifier of the first client device 104-1. In particular, the altered provider object 502 comprises a description of a flight (e.g. having number “AC123”) that has a fare of $150, and is from Toronto (e.g. airport having code “YYZ”) to Nice (e.g. airport having code “NCE”) on Jun. 8, 2022, and may be provided at the display screen 116 associated with the second client device 104-2, for example at an interface (e.g. a graphic user interface); the altered provider object 502 further comprises text “Enjoy The Best Airline In The World” which may comprise a marketing phrase for the provider object 1202, and/or any other suitable text. The altered provider object 502 further comprises a network address 504 of an image 506 stored at a media server 508 (e.g. which may be a component of the provider system 102 and/or a component of one or more of the computing devices 108). The network address 504 of the image 506 is understood to be provided in the form of a URL “ProvSys2.abc/img/EcoP1041.png”. It is further understood that an original network address of the image 506 was “ProvSys2.abc/img/EcoP.png” (e.g. in a corresponding altered provider object), and that the original network address was altered to include an identifier “1041” of the first client device 104-1. Hence, when altered data of the altered provider object 502 (e.g. the network address 504 “ProvSys2.abc/img/EcoP1041.png”) is received at the receiving computing device 108-3 from the second client device 104-2, the one or more computing devices 108 may identify the first client device 104-1 from the altered data and specifically the identifier “1041” embedded in the network address 504. Indeed, in this example, the image 506 may or may not be downloaded for viewing at the display screen 116. It is further understood in these examples that the network address of the image 506 stored at the media server 508 is altered to correspond with the network address 504.

Attention is next directed to FIG. 6, which depicts an example of an altered provider object 602 that is substantially similar to the altered provider object 502, with like components having like numbers, but in a “600” series rather than a “500” series, unless otherwise indicated. Hence, the altered provider object 602 includes a similar description for the same flight as the provider object 502, and the altered provider object 602 further comprises a network address 604 of an image 606 stored at the media server 508. As depicted, in these examples, the network address 604 of the image 606 is understood to be similar to the network address 504 and includes the identifier “1041” of the first client device 104-1. However, in other examples, the network address 604 of the image 606 may omit the identifier “1041” of the first client device 104-1.

In contrast to the example of FIG. 5, the image 606 includes the identifier “1041” of the first client device 104-1 embedded in the image 606 as steganographic data 608. While the steganographic data 608 is visible in FIG. 6 for clarity, it is understood that the steganographic data 608 is generally concealed according to steganographic techniques, and hence may not be visible to a user of the second client device 104-2 when the image 606 is rendered at the display screen 116. It is understood, in this example, that the image 606 has been altered (e.g. at the block 304 of the method 300), relative to the image 506, to include the steganographic data 608 and, hence, when altered data of the altered provider object 602 (e.g. the image 606, and/or alternatively the network address 604) is received at the receiving computing device 108-3 from the second client device 104-2, the one or more computing devices 108 may identify the first client device 104-1 from the steganographic data 608 and specifically the identifier “1041” embedded in the image 606. In these examples it is further understood that the image 606 has been downloaded to the second client device 104-2; such a download may occur via receipt of the image 606 in the altered data of the altered provider object 602, and/or via receiving the network address 604 in the altered data of the altered provider object 602 and downloading from the media server 508 via the network address 604.

However, in yet further examples, the second client device 104-2 may not download the image 606; rather, the second client device 104-2, may add the network address 604 in an interface (e.g. a graphic user interface, which may be rendered at the display screen 116, for example that includes the altered provider object 602), such that the second client device 104-2 “points” to the media server 508 (e.g. without an intermediary download). In these examples, it is understood that the image 606 may be “embedded” in the interface by way of the network address 604.

Attention is next directed to FIG. 7, which depicts an example of an altered provider object 702 that is substantially similar to the altered provider object 502, with like components having like numbers, but in a “700” series rather than a “500” series, unless otherwise indicated. Hence, the altered provider object 702 includes a similar description for the same flight as the provider object 502, and the altered provider object 702 further comprises a network address 704 of an image 706 stored at the media server 508. In contrast to the examples of FIG. 5 and FIG. 6, neither the network address 704 nor the image 706 has been altered to include an identifier “1041” of the first client device 104-1.

However, in further contrast to the examples of FIG. 5 and FIG. 6, the text 708 “Enjoy The Best Airline In The World” has been altered (e.g. relative to similar text in the examples of FIG. 5 and FIG. 6) to include the identifier “1041” of the first client device 104-1 (e.g. as appended thereto). Hence, when altered data of the altered provider object 702 (e.g. the text 708) is received at the receiving computing device 108-3 from the second client device 104-2, the one or more computing devices 108 may identify the first client device 104-1 from the text 708 and specifically the identifier “1041” included and/or embedded in the text 708.

Attention is next directed to FIG. 8, which depicts an example of an altered provider object 702 that is substantially similar to the altered provider object 502, with like components having like numbers, but in an “800” series rather than a “500” series, unless otherwise indicated. Hence, the altered provider object 802 includes a similar description for the same flight as the provider object 502, and the altered provider object 802 further comprises a network address 804 of an image (not depicted) stored at the media server 508 (not depicted). In contrast to the examples of FIG. 5 and FIG. 6, neither the network address 704 nor the image has been altered to include an identifier “1041” of the first client device 104-1. Furthermore, as depicted the text 808 is different from the text of the altered provider objects 502, 602, 702.

In particular, the text 808 of “The Best Airline In The World!” is associated with the first client device 104-1 via a record 114-1 stored at the association database 112, which includes the text 808 and associated identifiers 810-1 of the first client device 104-1 (e.g. the identifier “1041”), and another client device (e.g. not depicted herein) identified by an identifier 810 of “1043”. Hence, the record 114-1 indicates that the client devices 104 identified by the identifiers 810-1 are associated with the text 808. The client devices 104 that are associated with each other via the text 808 may referred to as being “clustered” together (e.g. associated with each other).

Similarly, a record 114-2 stored at the association database 112, includes text 812 of “Our Airline Is The Best” and associated identifiers 810-2 of the second client device 104-2 (e.g. the identifier “1042”), and another client device (e.g. not depicted herein) identified by an identifier 810 of “1044”. Hence, the record 114-2 indicates that the client devices 104 identified by the identifiers 810-2 are associated with the text 812. The client devices 104 that are associated with each other via the text 812 may referred to as being “clustered” together (e.g. associated with each other).

Hence, it is understood that, when provider objects are generated by the provider system 102 for the first client device 104-1 and a client device 104 identified by an identifier 810-1 of “1043”, the provider objects are altered to include the text 808. Put another way the first client device 104-1 and the client device 104 identified by an identifier 810 of “1043” are understood to be associated.

Similarly, it is understood that, when provider objects are generated by the provider system 102 for the second client device 104-2 and a client device 104 identified by an identifier 810-2 of “1044”, the provider objects are altered to include the text 812; put another way the second client device 104-2 and the client device 104 identified by an identifier 810 of “1044” are understood to be associated.

Hence, when altered data of the altered provider object 802 (e.g. the text 808) is received at the receiving computing device 108-3 from the second client device 104-2, the one or more computing devices 108 may identify the first client device 104-1 from the text 808 and specifically the text 808, for example, when comparing the text 808 with the records 114-1. 114-2. In this example, the one or more computing devices 108 may further determine a lack of association between the first client device 104-1 and the second client device 104-2 via the text 808 and the records 114-1, 114-2.

Attention is next directed to FIG. 9, which depicts an example of an altered provider object 902 that is substantially similar to the altered provider object 502, with like components having like numbers, but in a “900” series rather than a “500” series, unless otherwise indicated. Hence, the altered provider object 902 includes a similar description for the same flight as the provider object 502, and the altered provider object 902 further comprises a network address 904 of an image (not depicted) stored at the media server 508 (not depicted). In contrast to the examples of FIG. 5, FIG. 6, FIG. 7 and FIG. 8, neither the network address 904 nor the image has been altered, and neither has the text 908 been altered.

However, the altered provider object 902 has been altered to include a price structure 910-1 that breaks down the fare of $150 into a base fare of $100, a surcharge of $48, and an add-on fee of $2 (e.g. for a checked bag and the like). The surcharge may be for any suitable reason; indeed, airlines may generally add surcharges to fares for various types of fare classes.

In particular, the price structure 910-1 may be associated with the first client device 104-1, as stored at one or more of the databases 110, 112 (and/or a different database and/or memory). For example, as depicted, one or more of the databases 110, 112 store different price structures 910 associated with the first client device 104-1 and the second client device 104-2 in a tabular format (though any suitable format is within the scope of the present specification). In particular, as depicted, for a fare of $150, the first client device 104-1 is understood to be associated with the price structure 910-1 comprising a base fare of $100, a surcharge of $48, and an add-on fee of $2, which has been incorporated into the altered provider object 902.

In contrast, for a fare of $150, the second client device 104-2 is understood to be associated with the price structure 910-2 comprising a base fare of $100, a surcharge of $47, and an add-on fee of $3. It is understood that the price structures 910-1, 910-2 may be any suitable price structures that are different from one another.

Hence, from the price structure 910-1 included in altered data of the altered provider object 902, the one or more computing devices 108 may identify the first client device 104-1 (e.g. at the block 310 of the method 300).

Attention is next directed to FIG. 10, which depicts yet another example of an altered provider object 1002 provided in the form of a ticket itinerary. In examples heretofore, it has been understood that provider objects were generated in response to an initial search, for example initiated by the receiving computing device 108-3. However, in the example of FIG. 10, it is understood that a provider object for a flight, and the like, may alternatively be provided once the flight, and the like, is booked (e.g. and at least partially paid for), in the form of ticket itinerary as depicted in FIG. 10.

In this example, the altered provider object 1002 is understood to have been provided to the first client device 104-1 by the provider system 102, and the first client device 104-1 is understood to have provided the altered provider object 1002 to the second client device 104-2, which may have provided the altered provider object 1002 to a customer and/or to a user of the second client device 104-2. In some examples, the altered provider object 1002 may be received at the provider system 102 in the form of an image of the altered provider object 1002. Alternatively, the second client device 104-2 may have provided the altered provider object 1002 to the receiving computing device 108-3 (e.g. which may have purchased the altered provider object 1002). Regardless, it is understood that the altered provider object 1002 is associated with the second client device 104-2.

As depicted, the altered provider object 1002 has been altered to include altered data that includes various identifiers of the first client device 104-1, which enables the one or more computing devices 108 to identify the first client device 104-1. For example, the altered provider object 1002 includes a logo associated with the first client device 104-1, a ticket number 1006, and a booking reference 1008. In particular the ticket number 1006, and the booking reference 1008 have been altered to include an identifier “1041” of the first client device 104-1. It is understood that any of the logo 1004, the ticket number 1006, and the booking reference 1008 may be processed by the one or more computing devices 108 to identify (e.g. at the block 310) the first client device 104-1.

In general, examples heretofore provided may enable the one or more computing devices 108 to determine that the second client device 104-2 is using the first client device 104-1 as a proxy to provide provider objects; such examples rely, however, on the one or more computing devices 108 altering data of a provider object to identify the first client device 104-1.

However, in other examples, data received at the provider system 102 from the second client device 104-2, via the first client device 104-1, may enable the one or more computing devices 108 to determine that the second client device 104-2 is using the first client device 104-1 as a proxy to provide provider objects.

Attention is now directed to FIG. 11, which depicts a flowchart representative of a method 1100 a method for initiating remedial actions based on data associated with a provider object, the data received from a first client device or a second client device, the first client device acting as a proxy for the second client device. The operations of the method 1100 of FIG. 11 correspond to machine readable instructions that are executed by the one or more computing devices 108, for example by a controller 202 of the one or more computing devices 108. In the illustrated example, the instructions represented by the blocks of FIG. 11 are stored at the memory 204 for example, as the application 206 and/or a module thereof. The method 1100 of FIG. 11 is one way in which the controller 202 and/or the one or more computing devices 108 and/or the system 100 may be configured. Furthermore, the following discussion of the method 1100 of FIG. 11 will lead to a further understanding of the system 100, and its various components.

The method 1100 of FIG. 11 need not be performed in the exact sequence as shown and likewise various blocks may be performed in parallel rather than in sequence. Accordingly, the elements of method 1100 are referred to herein as “blocks” rather than “steps.” The method 1100 of FIG. 11 may be implemented on variations of the system 100 of FIG. 1, as well.

At a block 1102, the controller 202 and/or the one more computing devices 108 generates a provider object representing at least one item provided by a provider system, the provider object associated with a request from the first client device 104-1. The block 1102 is generally understood to be similar to the block 302 of the method 300. It is understood that a request for a provider object has been received from the first client device 104-1, similar to as described herein as described with respect to the method 300, but such a request may originate from the second client device 104-2. Put another way, at the method 1100, similar to the method 300, the second client device 104-2 is understood to be using the first client device 104-1 as a proxy to request provider objects from the provider system 102. It is further understood that the request for a provider object may be initiated by the receiving computing device 108-3 as described with respect to the method 300.

At a block 1104, the controller 202 and/or the one more computing devices 108 provides the provider object to the first client device 104-1. The block 1104 is generally understood to be similar to the block 306 of the method 300; however, the provider object provided to the first client device 104-1 at the block 1104 may or may not be altered. Regardless, it is understood that the first client device 104-1 provides the provider object to the second client device 104-2, similar to as described herein with respect to the method 300.

At a block 1106, the controller 202 and/or the one more computing devices 108 receives, data associated with the provider object, the data being one or more of received from one or more of the first client device 104-1, the second client device 104-2 (e.g. different from the first client device 104-1), captured at the second client device 104-2, and associated with the second client device 104-2. In particular, the second client device 104-2 may transmit certain payment information for the provider object to the one more computing devices 108 via the first client device 104-1, or the second client device 104-2 may transmit certain payment information for the provider object to the one more computing devices 108. However, the data associated with the provider object may be any suitable data that is received at the first client device 104-1 from the second client device 104-2, and provided to the controller 202 and/or the one more computing devices 108 by the first client device 104-1, and/or the data associated with the provider object may be any suitable data that is provided to the controller 202 and/or the one more computing devices 108 by the second client device 104-2. Nonetheless, it is understood, as described hereafter, that the data associated with the provider object (e.g. received from the first client device 104-1 and/or the second client device 104-2, and/or captured at the second client device 104-2, and/or associated with the second client device 104-2) identifies both the first client device 104-1 and the second client device 104-2. While hereafter examples are provided in which the data is received at the controller 202 and/or the one more computing devices 108 from the first client device 104-1 or the second client device 104-2, it is understood that the data may be received via the image capture device 122, the scanner 124, and/or in any other suitable manner, for example similar to as described above with respect to the altered data 412.

At a block 1108, the controller 202 and/or the one more computing devices 108 determines whether the data includes information identifying the first client device 104-1 and the second client device 104-2.

For example, the controller 202 and/or the one more computing devices 108 generally processes the data received at the block 1106 to determine whether the data includes information that identifies both the first client device 104-1 and the second client device 104-2. Such information may include, but is not limited to, information at fields of the data, metadata, and/or any other suitable information. Specific examples of such information will be described in more detail below with respect to FIG. 12 and FIG. 13.

In response to determining that the data includes information that identifies both the first client device 104-1 and the second client device 104-2 (e.g. a “YES” decision at the block 1108), at a block 1110, the controller 202 and/or the one more computing devices 108 initiates a remedial action against one or more of the first client device 104-1 and the second client device 104-2. Such remedial actions may be similar to as described with respect to the method 300.

Returning to the block 1108, in response to determining that the data does not include information that identifies both the first client device 104-1 and the second client device 104-2 (e.g. a “NO” decision at the block 1108), at a block 1112, the controller 202 and/or the one more computing devices 108 does not initiate a remedial action against one or more of the first client device 104-1 and the second client device 104-2.

Attention is next directed to FIG. 12, and FIG. 13, which depicts an example of aspects of the method 1100. In particular, FIG. 12 is substantially similar to FIG. 1, with like components having like numbers.

With attention first directed to FIG. 12, it is understood in FIG. 12 that a provider object 1202 was generated by the one or more computing devices 108 (e.g. at the block 1102 of the method 1100), and was provided to the first client device 104-1 by the one or more computing devices 108 (e.g. at the block 1104 of the method 1100), which provided the provider object 1202 to the second client device 104-2. Hence, in FIG. 12, the provider object 1202 is located at the second client device 104-2.

It is further understood in FIG. 12 that an item represented by the provider object 1202 is to be purchased by the second client device 104-2 using the first client device 104-1 as a proxy. As such, the second client device 104-2 transmits a purchase request 1204 to the first client device 104-1, which transmits a corresponding purchase request 1206 to the provider object computing device 108-1 and/or a payment server of the provider system 102 (not depicted, but such a payment server may comprise a computing device 108). The first client device 104-1 may generate the corresponding purchase request 1206 from the purchase request 1204 and may attempt to remove information identifying the second client device 104-2; however, the corresponding purchase request 1206 may be the same as, and/or identical to, the purchase request 1204.

As depicted, the provider object computing device 108-1, and/or a payment server of the provider system 102, generates a payment page 1208, and in particular a payment redirection page. An example of such a payment page 1208 is described below with respect to FIG. 13, however such a payment page 1208 may include, but is not limited to, a payment redirection page which may be generated and/or provided by the provider system 102 and which may include any suitable combination of fields and/or electronic buttons, and the like, which may enable a user of the second client device 104-2, and in particular a purchaser of the item represented by the provider object 1202, to enter payment information, such as credit card number, and the like, and/or to be redirected to a payment system of a third party payment system such as a credit card company system and/or server, and the like. As the provider system 102 provides the payment page 1208 to the first client device 104-1, the provider system 102 may populate the payment page 1208 with one or more identifiers of the first client device 104-1, such as a logo, and the like (e.g. the logo 1004). The provider object computing device 108-1, and/or a payment server of the provider system 102 provides the payment page 1208 to the first client device 104-1 (e.g. in response to the corresponding purchase request 1206) which provides the payment page 1208 to the second client device 104-2.

The second client device 104-2 may provide the payment page 1208 at the display screen 116, and the like, and populate certain fields of the payment page 1208 with information identifying the second client device 104-2, such as a merchant name (e.g. an alphanumeric and/or natural text identifier of the second client device 104-2), and the like. In particular, the second client device 104-2 may provide the payment page 1208 at an interface (e.g. a graphic user interface), provided at the display screen 116.

Furthermore, a field for a credit card number, and the like, of a purchaser of the item represented by the provider object 1202 may be populated. Such a “purchaser” may include, but is not limited to, the receiving computing device 108-3, which may initiate the method 1100. Hence, in these examples, it is understood that the receiving computing device 108-3 may generally be configured to automatically purchase items represented by provider objects using a given credit card number, or other payment account information.

Once a payment is made, and/or in conjunction with a payment being made, the second client device 104-2 may provide payment information 1210 (e.g. the data of the block 1106) to the receiving computing device 108-3. In particular, the payment information 1210 may include, but is not limited to, one or more of the payment page 1208, a receipt of a payment, and the like, and/or any other suitable data that may be generated by the second client device 104-2 in conjunction with a payment for an item represented by the provider object 1202. Regardless, the payment information 1210 is understood to include information identifying the first client device 104-1, such as the logo 1004, and the like, as well as information identifying the second client device 104-2; hence payment information 1210 may correspond to the data of the block 1106 received from the second client device 104-2.

Furthermore, as depicted, the second client device 104-2 may provide, to the provider object computing device 108-1 and/or a payment server of the provider system 102, via the first client device 104-1, information 1212 identifying a payment account, and the like, that the second client device 104-2 may use to pay the provider system 102 for the item represented by the provider object 1202. In particular, in these examples, the second client device 104-2 may accept payment for the item represented by the provider object 1202 from a purchaser of the item via a credit card of the purchase, but then remit payment for the item represented by the provider object 1202 to the provider system 102 via the first client device 104-1 using a payment account (e.g. a credit card number, a bank account, and the like) identified in the information 1212, the payment account associated with the second client device 104-2, which may have been previously registered with the provider system 102.

As depicted, the first client device 104-1 receives the information 1212 and transmits corresponding information 1214 to the provider object computing device 108-1 and/or a payment server of the provider system 102, the corresponding information 1214 identifying the payment account identified in the information 1212. The corresponding information 1214 may be the same as the information 1212, but may include metadata identifying the corresponding information 1214 as having been transmitted by the first client device 104-1 (e.g. and not the second client device 104-2). Hence, the corresponding information 1214 is understood to include information identifying the first client device 104-1, such as the metadata indicating that the corresponding information 1214 is transmitted by the first client device 104-1 1004, and the like, as well as information identifying the second client device 104-2, such as the payment account identified in the information 1212; hence corresponding information 1214 may correspond to the data of the block 1106 received from the first client device 104-1.

One or more of the computing devices 108 may analyze and/or process the payment information 1210 and/or the corresponding information 1214 to determine (e.g. at the block 1108 of the method 1100) whether the payment information 1210 and/or the corresponding information 1214 includes information identifying both the first client device 104-1 and the second client device 104-2, different from the first client device 104-1. When the payment information 1210 and/or the corresponding information 1214 is determined to include information identifying both the first client device 104-1 and the second client device 104-2, one or more of the computing devices 108 may initiate (e.g. at the block 1110 of the method 1100) a remedial action.

While not depicted, it is further understood that at least the payment information 1210 may be captured via the image capture device 122 (e.g. an image of the payment information 1210) at the display screen 116, and the like, and may be provided to the provider system 102 via the image capture device 122. However, the scanner 124 may alternatively capture aspects of the payment information 1210 and/or the corresponding information 1214 when embedded into a code 1216 (e.g. it is understood that the code 1216 includes information that identifies both the first client device 104-1 and the second client device 104-2).

Attention is next directed to FIG. 13, which depicts examples of the payment page 1208, the payment information 1210 and the corresponding information 1214.

As depicted in FIG. 13, the payment page 1208 includes an amount to be paid for a provider object and/or a corresponding item, and a date (e.g. $150 and May 25, 2022, respectively), such as a payment date, and the like.

As depicted, the payment page 1208 further includes a merchant name field 1302, a payment account field 1304 and a logo field 1306. The merchant name field 1302 is understood to be populated by any client device 104, that receives the payment page 1208, with a corresponding name (e.g. a name registered with the provider system 102) of an entity associated with the client device 104, such as the second client device 104-2.

The payment account field 1304 is understood to be populated by any client device 104, and the like, accepting a payment with a corresponding payment account number, for example a credit card number of a purchaser of an item represented by a provider object.

However, the logo field 1306 is understood to be populated by the provider system 102 with a corresponding logo and/or trademark, and the like of a client device 104 from which a purchase request, and the like, is received, such as the first client device 104-1. Hence, for example, as the provider system 102 receives the corresponding purchase request 1206 from the first client device 104-1, the provider system 102 populates the logo field 1306 with the logo 1004 associated with the first client device 104-1; the logo 1004 may be received from the first client device 104-1 with the corresponding purchase request 1206 and/or the logo 1004 may have been previously registered with the provider system 102.

As depicted, the payment information 1212 generated by the second client device 104-2 comprises the payment page 1208 with the fields 1302, 1304, 1304 populated. For example, as depicted. the field 1302 has been populated with an entity name “SecondClient1042” which may comprise a name of an entity associated with the second client device 104-2 that has been registered with the provider system 102.

Furthermore, as depicted, the field 1304 has been populated with a payment account number “1234 5678 9101 1213” which may comprise a credit card number (e.g. and/or an account number) of a purchaser of the item represented by the provider object 1202 (and/or any item representing any provider object being purchased).

However, as depicted, the field 1306 has been populated with the logo 1004 of an entity associated with the first client device 104-1. It is understood in these examples that information populating the fields 1302, 1304 are changeable via the second client device 104-2, however the field 1306, once populated with the logo 1004 associated with the first client device 104-1, is not changeable by the second client device 104-2. For example, the payment page 1208 may include rules and/or metadata that define when one or more of the fields 1302, 1304, 1306 may be populated. For example, such rules and/or metadata may allow the logo field 1306 to be populated once and not changed.

As depicted, the corresponding information 1214 is understood to have been generated by the first client device 104-1 based on the information 1212 received from the second client device 104-2. The corresponding information 1214 includes an identifier of the sender of the corresponding information 1214, for example an entity name “FirstClient1041” which may comprise a name of an entity associated with the first client device 104-1 that has been registered with the provider system 102. As depicted, the identifier of the sender of the corresponding information 1214 may be provided via metadata 1308 of the corresponding information 1214. Furthermore, the identifier of the sender of the corresponding information 1214 may comprise any suitable information such as a network address of the first client device 104-1, and the like.

As depicted, the corresponding information 1214 further includes an amount to be paid for a provider object and/or a corresponding item, and a date (e.g. $150 and May 25, 2022, respectively), such as a payment date, and the like, similar to the payment information 1210.

However, as depicted, the corresponding information 1214 includes a payment account number “1415 1617 1819 2021” associated with the second client device 104-2. In general, the first client device 104-1 may not change the payment account number “1415 1617 1819 2021” associated with the second client device 104-2 as the first client device 104-1 may be acting as a proxy for the second client device 104-2 for communications with the provider system 102, but not for payment.

Regardless, it is understood that the payment information 1210 and the corresponding information 1214 both includes information that identifies both the first client device 104-1 and the second client device 104-2, and hence enables the provider system 102 to determine when to initiate a remedial action at the block 1110 of the method 1100.

As such, it is understood that the method 1100 may further comprise (e.g. using the example of FIG. 12): generating, via the one or more computing devices 108, a payment page 1208 that includes fields 1302, 1304, 1306 to identify the first client device 104-1 and the second client device 104-2; providing, via the one or more computing devices 108, the payment page 1208 to the first client device 104-1, wherein receiving (e.g. at the block 1106 of the method 1100) the data (e.g. from the first client device 104-1 and/or the second client device 104-2 and/or the image capture device 122 and/or the scanner 124) comprises receiving, from the second client device 104-2 (and/or the image capture device 122), the payment page 1208 with the fields 1302, 1304, 1306 populated (e.g. in the form of the payment information 1210) to identify the first client device 104-1 and the second client device 104-2, and wherein determining (e.g. a “YES” decision at the block 1108 of the method 1100) that the data includes information identifying the second client device and the first client device comprises determining that the payment page 1208 as received from the second client device 104-2 identifies the first client device 104-1 and the second client device 104-2.

Furthermore, it is understood that the method 1100 may further comprise (e.g. also using the example of FIG. 12): receiving (e.g. at the block 1106 of the method 1100) the data by receiving information from the first client device 104-1 that identifies a payment account associated with the second client device 104-2, and determining (e.g. a “YES” decision at the block 1108 of the method 1100) that the data includes information identifying the first client device 104-1 and the second client device 104-2 comprises determining that the payment account is associated with the second client device 104-2 and not the first client device 104-1 from which the data is received, the data including an identifier of the first client device 104-1.

Furthermore, while examples of the method 1100 are described herein are described herein with respect to payments for provider objects, data associated with a provider object that is received at the block 1106 of the method 1100 may comprise any suitable data. For example, after a provider object is received at the second client device 104-2, the second client device 104-2 may request further information regarding the provider object from the provider system 102 via the first client device 104-1; such further information may include, but is not limited to, a final price, and the like.

As should by now be apparent, the operations and functions of the devices described herein are sufficiently complex as to require their implementation on a computer system, and cannot be performed, as a practical matter, in the human mind. In particular, computing devices, and the lie, such as set forth herein are understood as requiring and providing speed and accuracy and complexity management that are not obtainable by human mental steps, in addition to the inherently digital nature of such operations (e.g., a human mind cannot interface directly with, RAM or other digital storage, cannot transmit or receive electronic messages, among other features and functions set forth herein).

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown), which stores computer-readable program code for operation of the computing apparatus. The computer-readable program code could be stored on a computer readable storage medium, which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

What is claimed is:

1. A method comprising:
generating, via one or more computing devices, a provider object representing at least one item provided by a provider system, the provider object including data, the provider object associated with a request from a first client device;
altering, via the one or more computing devices, the data to identify the provider object as being associated with the first client device, to generate an altered provider object comprising altered data that identifies the first client device;
providing, via the one or more computing devices, the altered provider object to the first client device;
receiving, via the one or more computing devices, the altered data of the altered provider object, the altered data being one or more of received from a second client device, captured at the second client device, and associated with the second client device;
identifying, via the one or more computing devices, the first client device from the altered data; and
in response to determining a lack of association between the first client device and the second client device, initiating a remedial action against one or more of the first client device and the second client device.

2. The method of claim 1, wherein altering the data comprises one or more of:
embedding one or more identifiers of the first client device into the altered data;
embedding the one or more identifiers of the first client device into media identified by the altered data;
embedding the one or more identifiers of the first client device into one or more of a name and a network address of the media identified by the altered data;
changing a first pricing structure of the data to second pricing structure of the altered data, the second pricing structure identifying the first client device;
changing an alphanumeric identifier associated with the provider object to identify the first client device; and
adding text to the altered data that identifies the first client device.

3. The method of claim 1, wherein determining the lack of association between the first client device and the second client device occurs using a memory storing associations between client devices.

4. The method of claim 1, wherein determining the lack of association between the first client device and the second client device is based on text of the altered data that identifies the first client device, the text associated with the first client device and not the second client device.

5. The method of claim 1, wherein the remedial action comprises one or more of:
invalidating the provider object;
denying access to the provider object by one or more of the first client device and the second client device, wherein denial of the access to the provider object occurs temporarily or permanently;
changing further provider objects associated with the first client device to respective provider objects associated with the second client device;
changing prices or services of the further provider objects associated with the first client device to altered prices or altered services; and,
one or more of initiating and applying a financial penalty against one or more of the first client device and the second client device.

6. The method of claim 1, further comprising:
requesting, via the one or more computing devices, the provider object from the second client device;
receiving, via the one or more computing devices, a request for the provider object from the first client device, the provider object generated in response to the request;
providing, via the one or more computing devices, the altered provider object, including the altered data, to the first client device; and
receiving, via the one or more computing devices, the altered data of the altered provider object from the second client device.

7. The method of claim 1, wherein receiving the altered data occurs as part of receiving scraped content associated with the second client device.

8. The method of claim 1, wherein receiving the altered data occurs by receiving one or more of an image of the altered data and a scan of the altered data.

9. A computing device comprising:
a communication interface; and
a controller configured to:
generate a provider object representing at least one item provided by a provider system, the provider object including data, the provider object associated with a request from a first client device;
alter the data to identify the provider object as being associated with the first client device, to generate an altered provider object comprising altered data that identifies the first client device;
provide, via the communication interface, the altered provider object to the first client device;
receive, via the communication interface, the altered data of the altered provider object, the altered data being one or more of received from a second client device, captured at the second client device, and associated with the second client device;
identify the first client device from the altered data; and
in response to determining a lack of association between the first client device and the second client device, initiate a remedial action against one or more of the first client device and the second client device.

10. The computing device of claim 9, wherein the controller is further configured to alter the data by one or more of:
embedding one or more identifiers of the first client device into the altered data;
embedding the one or more identifiers of the first client device into media identified by the altered data;
embedding the one or more identifiers of the first client device into one or more of a name and a network address of the media identified by the altered data;
changing a first pricing structure of the data to second pricing structure of the altered data, the second pricing structure identifying the first client device;
changing an alphanumeric identifier associated with the provider object to identify the first client device; and
adding text to the altered data that identifies the first client device.

11. The computing device of claim 9, wherein the controller is further configured to determine the lack of association between the first client device and the second client device by using a memory storing associations between client devices.

12. The computing device of claim 9, wherein the controller is further configured to determine the lack of association between the first client device and the second client device based on text of the altered data that identifies the first client device, the text associated with the first client device and not the second client device.

13. The computing device of claim 9, wherein the remedial action comprises one or more of:
invalidating the provider object;
denying access to the provider object by one or more of the first client device and the second client device, wherein denial of the access to the provider object occurs temporarily or permanently;
changing further provider objects associated with the first client device to respective provider objects associated with the second client device;
changing prices or services of the further provider objects associated with the first client device to altered prices or altered services; and,
one or more of initiating and applying a financial penalty against one or more of the first client device and the second client device.

14. The computing device of claim 9, wherein the controller is further configured to:
request the provider object from the second client device;
receive a request for the provider object from the first client device, the provider object generated in response to the request;
provide the altered provider object, including the altered data, to the first client device; and
receive the altered data of the altered provider object from the second client device.

15. The computing device of claim 9, wherein the controller is further configured to receive the altered data occurs as part of receiving scraped content associated with the second client device.

16. The computing device of claim 9, wherein the controller is further configured to receive the altered data by receiving one or more of an image of the altered data and a scan of the altered data.

17. A method comprising:
generating, via one or more computing devices, a provider object representing at least one item provided by a provider system, the provider object associated with a request from a first client device;
providing, via the one or more computing devices, the provider object to the first client device;
receiving, via the one or more computing devices, data associated with the provider object, the data being one or more of received from one or more of the first client device, a second client device, captured at the second client device, and associated with the second client device;
determining, via the one or more computing devices, that the data includes information identifying the first client device and the second client device; and,
in response, initiating a remedial action against one or more of the first client device and the second client device.

18. The method of claim 17, further comprising:
generating, via the one or more computing devices, a payment page that includes fields to identify the first client device and the second client device; and
providing, via the one or more computing devices, the payment page to the first client device,
wherein receiving the data comprises receiving the payment page with the fields populated to identify the first client device and the second client device, and
wherein determining that the data includes information identifying the second client device and the first client device comprises determining that the payment page as received from the second client device identifies the first client device and the second client device.

19. The method of claim 17, wherein receiving the data comprises receiving information from the first client device that identifies a payment account associated with the second client device, and
wherein determining that the data includes information identifying the second client device and the first client device comprises determining that the payment account is associated with the second client device and not the first client device from which the data is received, the data including an identifier of the first client device.

20. A computing device comprising:
a communication interface; and
a controller configured to:
generate a provider object representing at least one item provided by a provider system, the provider object associated with a request from a first client device;
provide, via the communication interface, the provider object to the first client device;
receive, via the communication interface, data associated with the provider object, the data being one or more of received from one or more of the first client device, a second client device, captured at the second client device, and associated with the second client device;
determine that the data includes information identifying the first client device and the second client device; and,
in response, initiate a remedial action against one or more of the first client device and the second client device.
